(19) United States
(12) Patent Application Publication
(10) Pub. No.: US 2025/0217030 A1
(43) Pub. Date: Jul. 3, 2025

(54) Text Entry with Finger Tapping and Gaze-Directed Word Selection

(71) Applicants: Zhenyi He, New York, NY (US); Christof Lutteroth, Bathampton (GB); Kenneth Perlin, New York, NY (US)

(72) Inventors: Zhenyi He, New York, NY (US); Christof Lutteroth, Bathampton (GB); Kenneth Perlin, New York, NY (US)

(73) Assignees: New York University, New York, NY (US); University of Bath, Bath (GB)

(21) Appl. No.: 18/850,052

(22) PCT Filed: Mar. 29, 2023
(86) PCT No.: PCT/US2023/016774

§ 371 Date: Sep. 23, 2024

Related U.S. Application Data
(60) Provisional application No. 63/325,952, filed on Mar. 31, 2022.

(51) Int. Cl. G06F 3/04886; G06F 3/01; G06F 3/04815

(52) U.S. Cl. CPC G06F 3/04886; G06F 3/013; G06F 3/04815

(57) ABSTRACT

A text entry apparatus, storage medium and method where users type by tapping their fingers in place, called TapGazer, is presented. Users can tap anywhere as long as the identity of each tapping finger can be detected with sensors. The ambiguity between different possible input words is resolved by selecting target words with gaze. If gaze tracking is unavailable, ambiguity is resolved by selecting target words with additional taps.

### CROSS-REFERENCE TO RELATED APPLICATIONS

This is a PCT application which claims priority from U.S. provisional application Ser. No. 63/325,952 filed Mar. 31, 2022, incorporated by reference herein.

### FIELD OF THE INVENTION

The present invention is related to text entry with finger tapping. More specifically, the present invention is related to text entry with finger tapping and gaze-directed word selection into Virtual Reality (VR).

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

While using VR, efficient text entry is a challenge: users cannot easily locate standard physical keyboards, and keys are often out of reach, e.g., when standing. Text entry is one of the most frequent, important, and demanding tasks in personal computing. Because efficient text entry methods are crucial to productivity, an enormous amount of research has been conducted on methods that improve their usability. As new types of electronic devices such as smartphones have become available, new text entry methods have been proposed [3, 25, 96]. With the increasing popularity of (VR), there is an expanding interest in text entry methods that can support VR users [40, 55, 110, 112]. While using VR, efficient text entry poses the following challenges:
Proximity. VR users typically interact with virtual environments using their hands, often turning their bodies to change orientation, and are frequently standing or even walking in their VR usage area. These movements generally take a user's hands away from stationary physical keyboards, and often out of reach of the keys. Therefore, a versatile VR text entry method should allow users to be more mobile than with a standard physical keyboard and also relax the requirement of having to keep fingers aligned with keys. Related works have addressed this by proposing virtual keyboards controlled with VR headsets [103, 104], portable standard keyboards [33, 44, 80], and input methods using hands [50, 101], fingers [26, 36, 52, 67, 74, 94, 108, 109], gaze [48, 49, 65], or stylus [21].
Visibility. VR headsets occlude the real world, making it harder to locate physical keyboards, move to a suitable pose close to the keyboard, and align the fingers with the keys for efficient touch typing. Ideally, a VR text entry method should afford users awareness of physical keyboards, or avoid the use of a physical keyboard in the first place. Related works have addressed this by providing visual cues about the physical keyboard position [11, 33, 41, 44, 55, 69, 74, 97], attaching keyboards to a user's body so she is kinaesthetically aware of their position [80], or virtual keyboards that readily show up in the user's field of view [19, 53, 106].
Learnability. Because text entry is a basic task of computing systems, it should ideally be easy to learn. Many novel text entry methods require users to learn entirely new, non-standard text entry skills such as new keyboard layouts [7, 63, 85, 113]. However, as many users are already proficient in the use of a QWERTY keyboard, much previous work on VR text entry has aimed to exploit this familiarity to improve learnability [10, 33, 44, 80, 106].

To develop a fast and usable text entry design using tap and gaze, prior work was closely investigated in alternative keyboard layout design, gaze interaction, and text entry for VR and similar scenarios. An overview of the most relevant and fastest methods, with their average speeds in words per minute (WPM), is shown in Table 1. For works that reported users' QWERTY performance, also listed is the percentage of their QWFRTY WPM users were able to achieve.

TABLE 1
Summary of prior text entry solutions, ordered by their average WPMs

| | | % of QWERTY | |
|---|---|---|---|
| Design | Average WPMs | keyboard WPM | Examples |
| Typing QWERTY on | 17.2-44.6 | 74.59% [88] | BlindType [58], |
| a touch surface | | | PalmBoard [107], |
| | | | TOAST [88] |
| Tapping on tiny | 11.0-41.0 | | Ahn & Lee [3], |
| surface | | | Vertanen et al. [95], |
| | | | VelociTap [96] |
| Reduced physical | 7.3-30.0 | 37.17% [54] | Stick [32], 1Line |
| QWERTY keyboard | | | [54], LetterWise [61], |
| | | | VType [26] |
| Gesture typing | 15.6-34.2 | | GestureType [110], |
| | | | Chen et al. [17] |
| Mid-air chord gesture | 22.0-24.7 | | Sridhar et al. [93], |
| typing | | | Adhikary [2] |
| Typing with pinch | 11.9-23.4 | | TipText [105], |
| gestures | | | DigiTouch [101], |
| | | | BiTipText [105] |
| Mid-air finger | 17.8-23.0 | 49.24% [108] | VISAR [24], ATK |
| tapping | | | [108] |
| Tapping with head or | 7.25-21.1 | | PizzaText [112], |
| controller on a soft | | | RingText [104], |
| alternative keyboard | | | HiPad [40], Curved |
| | | | QWERTY [106], |
| | | | Boletsis & Kongsvik |
| | | | [10] |
| Tapping QWERTY | 11.3-15.6 | | Tap/Dwell [110] |
| with head or | | | |
| controller | | | |
| Gaze typing plus | 14.6-15.5 | | EyeSwipe [48, 49], |
| touch | | | TAGSwipe [47] |

For devices where a full-size physical keyboard is not available, many specialized text entry solutions have been proposed, e.g., for touch screens [43, 54, 88], mobile phones [25, 115], and handheld devices [15]. Moreover, using a finger [9, 76] or pen [45] for handwritten text input has been considered, although this is slow compared to typing. Speech-to-text is also a widely explored option with the potential to be faster than typing [86]; however, it has limited accuracy and is not always suitable, e.g., when the environment is noisy, other people are talking, or the content is of a sensitive or personal nature.

A key requirement of manual typing approaches is detection and tracking of the fingers. Gloves [52, 94], markers [36, 67], audio signals [98], cameras [84, 109], and specific devices such as Leap Motion [108] have all been investigated. Based on this, various input recognition methods have been proposed, with some recognizing input as single characters (‘character-level’) and others recognizing entire words (‘word-level’). Methods recognizing larger chunks of input (e.g., words, sentences [96]) are typically more effective than those recognizing characters [95]. Input prediction and correction methods can be used to improve the performance of text entry [20, 31, 75, 114].

### Alternative Keyboard Layouts

Some alternative layouts support a limited interaction size with a reduced number of keys, which makes them relevant for TapGazer. A common consideration is the similarity to familiar layouts such as QWERTY or T9 for learnability, e.g., for mobile phones [25, 61], smart glasses [3], and smartwatches [81]. Familiar layouts are often adapted to new typing gestures, e.g. using thumb-to-finger interaction for small-screen devices or VR/AR using split QWERTY [73, 101] or T9 layouts [102]. Another trend is rearranging keyboard characters into different 2D or 3D shapes: QuikWriting [79] and its gaze-version [5] distribute letters into a circle; PizzaText [112], WrisText [30], and HiPad [40] use a pie-shaped layout; Keycube [13] attaches push buttons to a physical magic cube for typing.

When applying a reduced keyboard layout, fingers or keys are not uniquely assigned to characters, so a mechanism for disambiguation becomes necessary. LetterWise [61] uses prefix-based rather than word-based disambiguation, i.e., users press a button if the current character is wrong and then the respective character of the next-likely prefix is shown. By repeatedly pressing the button, even non-dictionary words can be typed. Stick keyboard [32] compresses the QWERTY keyboard into one line, with each key mapped to 2-3 characters. Users choose one of several ambiguous words by scrolling through possible candidates with button presses. Similarly, 1 Line keyboard [54] reorganizes the QWERTY keyboard to a single line specifically for touchscreen typing, using touch gestures to support candidate selection.

Some previous work has looked at reduced QWERTY keyboards and word disambiguation. VType [26] applies a reduced keyboard layout, attempting to reconstruct words automatically based on finger sequence, grammar, and context, but does not allow users to choose between ambiguous words. The 1 Line keyboard [54] and the stick keyboard [32] flatten the QWERTY keyboard from three rows to one, allowing users to choose between ambiguous words through touchscreen gestures and arrow keys.

### BRIEF SUMMARY OF THE INVENTION

A text entry apparatus and method where users type by tapping their fingers in place, called TapGazer, is presented. Users can tap anywhere as long as the identity of each tapping finger can be detected with sensors. The ambiguity between different possible input words is resolved by selecting target words with gaze. If gaze tracking is unavailable, ambiguity is resolved by selecting target words with additional taps.

The present invention pertains to an apparatus for entering text by movement of fingers of a user having an eye. The apparatus comprises a sensor in communication with at least one finger of the fingers which detects movement of the at least one finger and produces a finger signal. The apparatus comprises a computer in communication with the sensor which receives the finger signal and associates proposed text with the finger signal. The apparatus comprises a display in communication with the computer upon which the proposed text is displayed. The apparatus may comprise an eye tracker in communication with the computer. The computer selecting desired text from the proposed text on the display based on the eye tracker identifying where the eye of the user gazes. Alternatively, the computer may select desired text from the proposed text on the display based on the finger signal.

The present invention pertains to a method for entering text by movement of fingers of a user having an eye. The method comprises the steps of moving at least one finger of the fingers. There is the step of causing a sensor in communication with the at least one finger to produce a finger signal. There is the step of receiving the finger signal at a computer. There is the step of associating by the computer proposed text with the finger signal. There is the step of displaying on the display the proposed text. There may be the step of identifying with an eye tracker where the user gazes onto the proposed text displayed on a display. There is the step of selecting desired text from the proposed text by the computer based on the eye tracker identifying where the eye of the user gazes. Alternatively, there may be the step of additional finger taps being used for word disambiguation without an eye tracker.

The present invention pertains to a non-transitory readable storage medium which includes a computer program stored on the storage medium for entering text by movement of fingers of a user having an eye. The storage medium having the computer-generated steps of associating proposed text from a finger signal obtained from a sensor in communication with at least one finger of the fingers moving. There is the step of displaying on a display the proposed text. There may be the step of identifying from an eye tracker where the user gazes onto the proposed text displayed on a display. There is the step of selecting desired text from the proposed text based on the eye tracker identifying where the eye of the user gazes. Alternatively, there may be the step of additional finger taps being used for word disambiguation without an eye tracker.

### BRIEF DESCRIPTION OF THE DRAWINGS

FIG. 1A shows the physical setup of TapGazer.

FIG. 1B shows a visual interface.

FIG. 1C shows a state machine of Tapgazer with gaze selection and word completion.

FIG. 1D is a block diagram of Tapgazer.

FIG. 1E is a block diagram of a storage medium.

FIG. 2A shows a user is ‘typing’ on her thighs using a TapStrap device instead of a keyboard.

FIG. 2B shows the user just started to ‘type’ the word “children”.

FIG. 2C shows the user first tapped the left middle finger (mapped to ‘c’).

FIG. 2D shows the right index finger (mapped to ‘h’).

FIG. 2E shows the right middle finger (mapped to ‘i’).

FIG. 2F shows the user looks at the word “children”, which gets highlighted with an underline as it is gazed upon, and taps the right thumb to select the highlighted word.

FIG. 3A shows a Lexical Layout which places the most common candidate word in the first row and arranges the other candidates in alphabetical order.

FIG. 3B shows a WordCloud Layout which emphasizes frequent candidates with a larger font size.

FIG. 3C shows a Division Layout which divides all candidates into three columns according to their last letter.

FIG. 3D shows a Pentagon Layout orders the candidates based on the frequency and arranges the candidates in a compact single or double pentagon shape, separating them for easier gaze selection.

FIG. 4 shows the TapGazer's workflow.

### DETAILED DESCRIPTION OF THE INVENTION

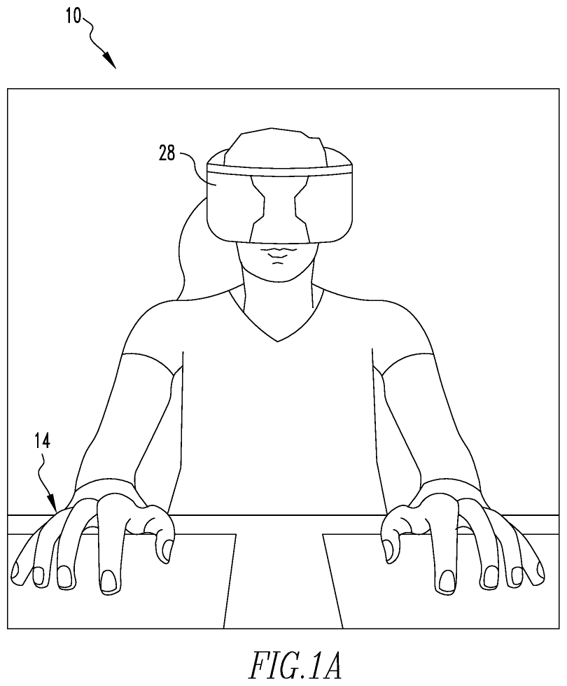

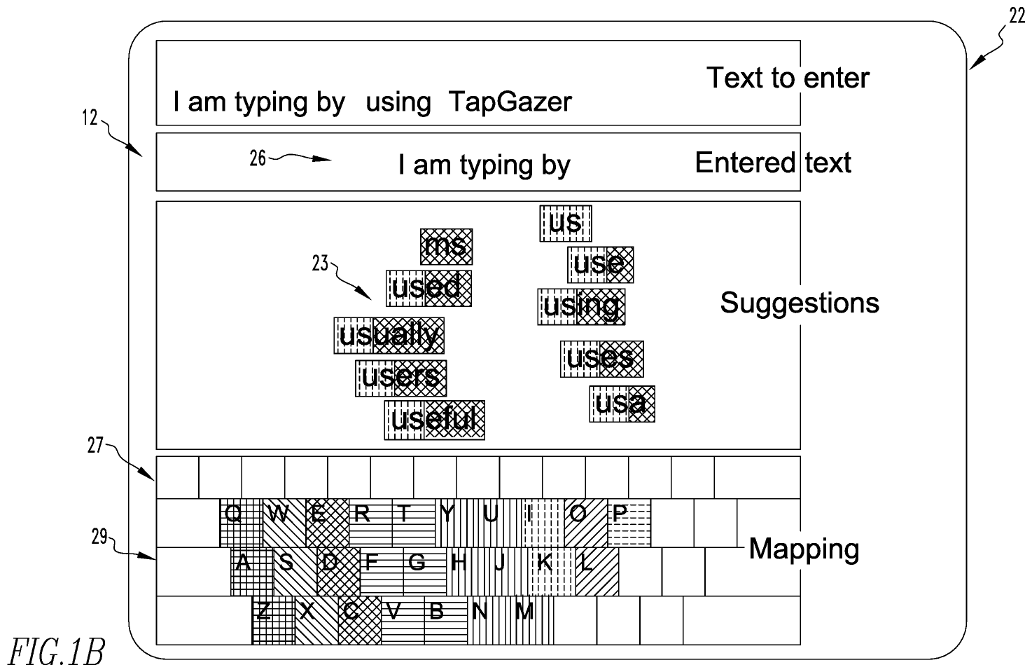

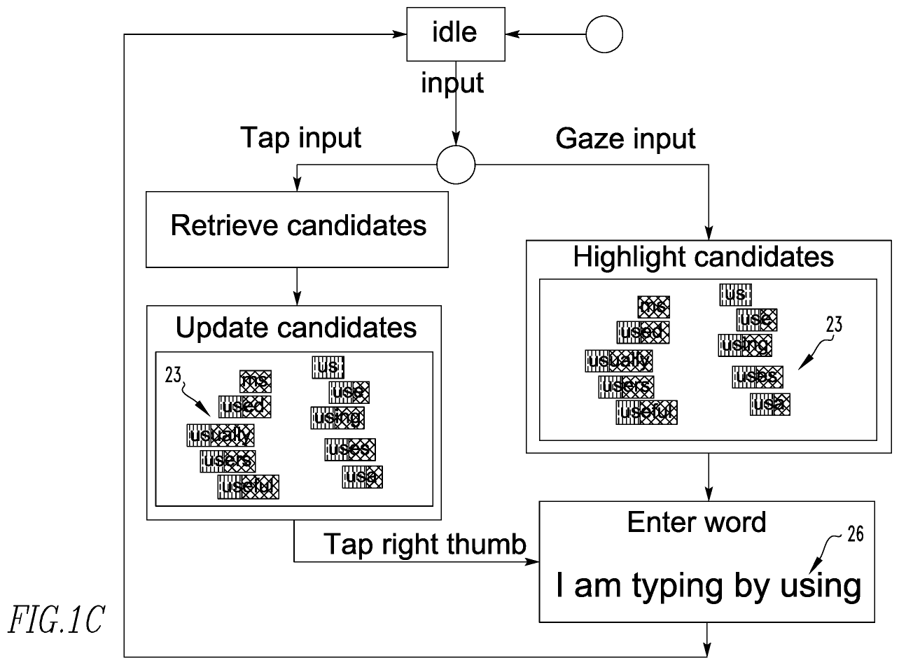

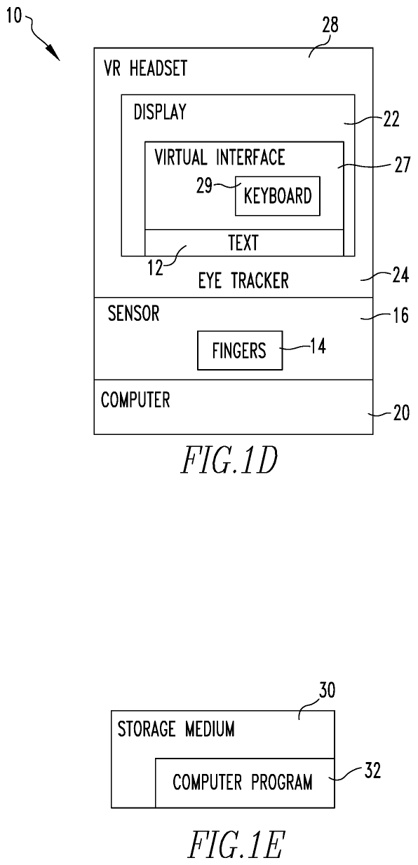

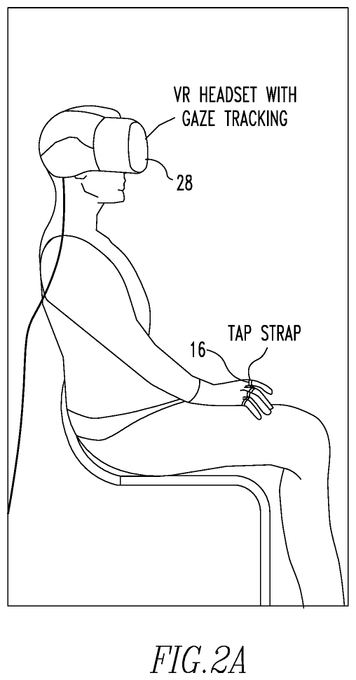

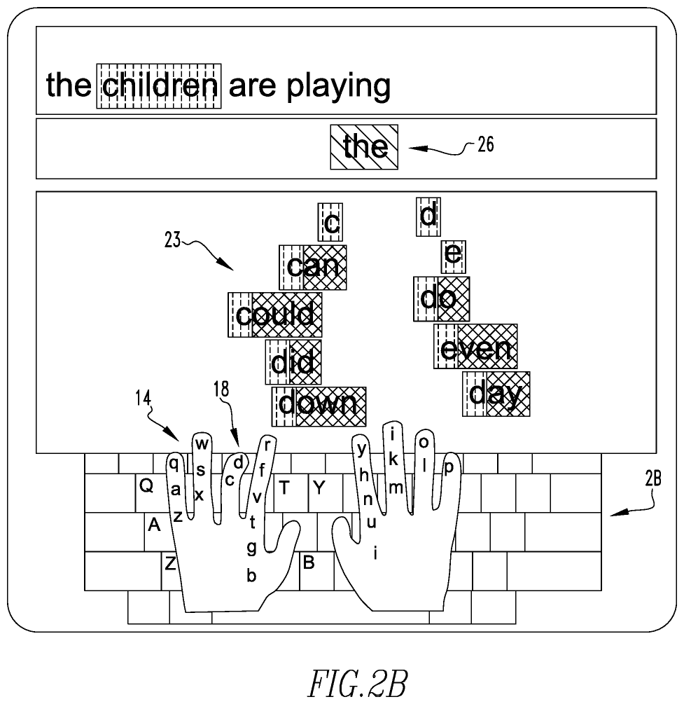

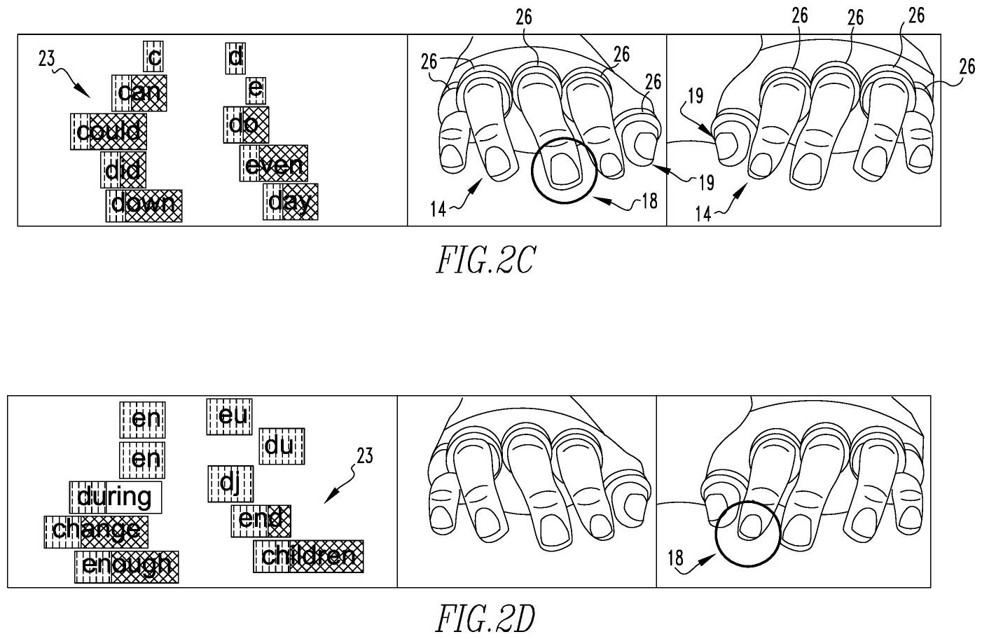

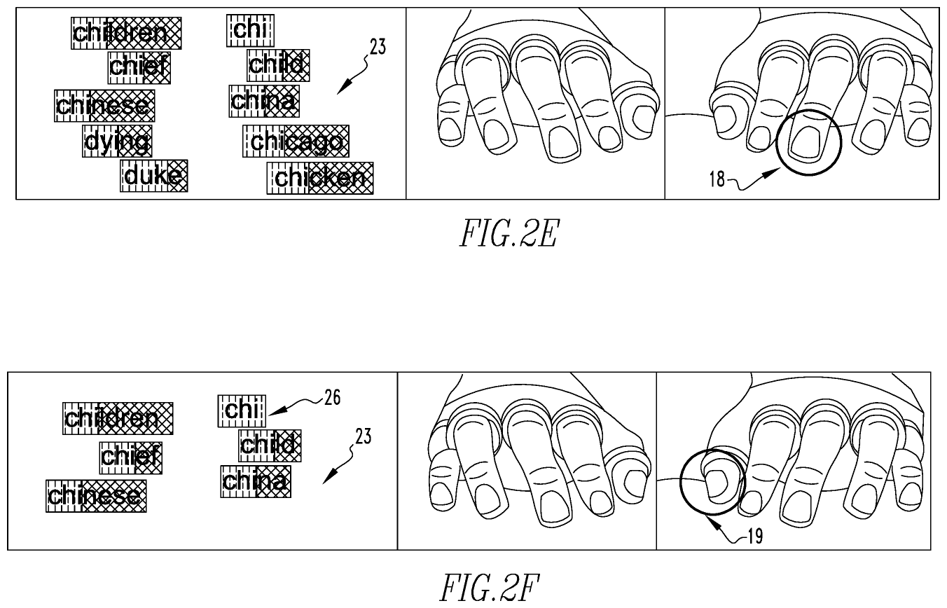

Referring now to the drawings wherein like reference numerals refer to similar or identical parts throughout the several views, and more specifically to FIGS. 1A-1D thereof, there is shown an apparatus for entering text 12 by movement of fingers 14 of a user having an eye. The apparatus 10 comprises a sensor 16 in communication with at least one finger 18 of the fingers 14 which detects movement of the at least one finger 18 and produces a finger signal. The apparatus 10 comprises a computer 20 in communication with the sensor 16 which receives the finger signal and associates proposed text 23 with the finger signal. The apparatus 10 comprises a display 22 in communication with the computer 20 upon which the proposed text 23 is displayed. The apparatus 10 comprises an eye tracker 24 in communication with the computer 20. The computer 20 selecting desired text 26 from the proposed text 23 on the display 22 based on the eye tracker 24 identifying where the eye of the user gazes. Alternatively, the computer 20 may select desired text 26 from the proposed text 23 on the display 22 based on the finger signal, as shown in FIGS. 2A-2F.

The apparatus 10 may include a virtual reality headset 28 having the display 22 which displays a virtual reality and the proposed text 23 in the virtual reality. The computer 20 may receive a second finger signal from the sensor 16 which causes the computer 20 to select the desired text 26. The computer 20 may select the desired text 26 based on either direct gaze pointing with dwell, eye switches, discrete gaze gestures, or continuous gaze.

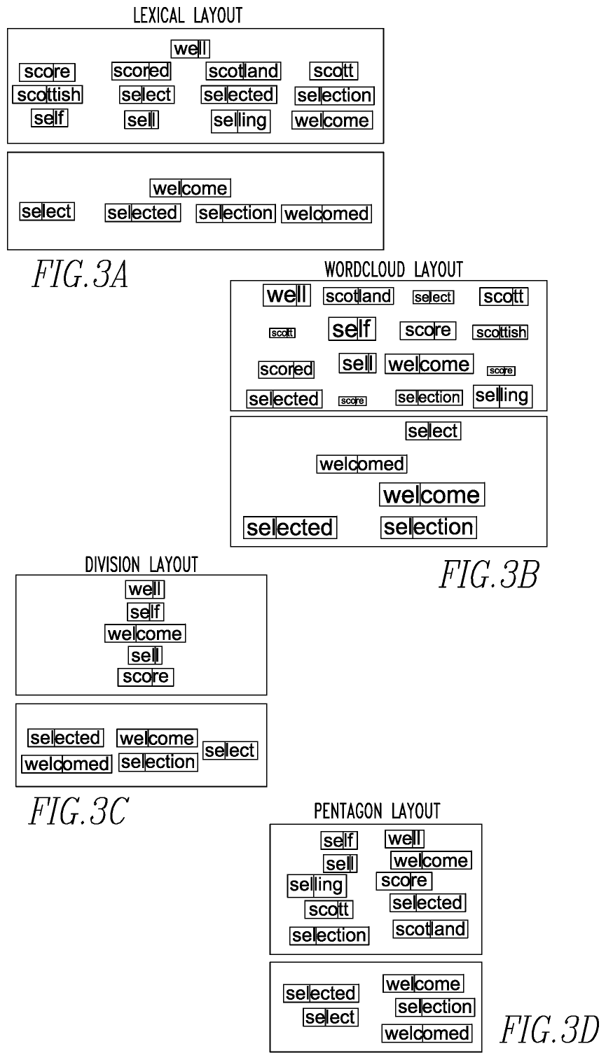

The computer 20 may track and visualize a physical keyboard 29 in the virtual reality to facilitate keyboard 29 text 12 entry in virtual reality, as shown in FIG. 2B. The computer 20 may display the proposed text 23 either a Lexical Layout, a WordCloud Layout, a Division Layout, or a Pentagon Layout, as shown in FIGS. 3A-3D. The fingers 14 include eight non-thumb fingers 14 and two thumbs 19 and the computer 20 may use finger to letter mapping where each of the 26 letters of the alphabet is mapped to at least one of the eight non-thumb fingers 14, while the two thumbs 19 are reserved for controlling editing functions for word selection, undoing a selection, deletion and cursor navigation, as shown in FIG. 2B.

The computer 20 may enable text 12 entry by finger tapping by assigning multiple letters to each finger and showing text 12 suggestions in the display 22 and allowing the user to select desired text 26 via the user's gaze and determine the desired text 26 selection via a thumb tap. The computer 20 may display a color-coded keyboard 29 layout in the display 22. The finger-to-letter mapping may be based on a QWERTY keyboard 29 layout.

The present invention pertains to a method for entering text 12 by movement of fingers 14 of a user having an eye. The method comprises the steps of moving at least one finger 18 of the fingers 14. There is the step of causing a sensor 16 in communication with the at least one finger 18 to produce a finger signal. There is the step of receiving the finger signal at a computer 20. There is the step of associating by the computer 20 proposed text 23 with the finger signal. There is the step of displaying on the display 22 the proposed text 23. There is the step of identifying with an eye tracker 24 where the user gazes onto the proposed text 23 displayed on a display 22. There is the step of selecting desired text 26 from the proposed text 23 by the computer 20 based on the eye tracker 24 identifying where the eye of the user gazes. There may be the step of the computer 20 receiving a second finger signal from the sensor 16 which causes the computer 20 to select the desired text 26. Alternatively, there may be the step of additional finger taps being used for word disambiguation without an eye tracker 24.

There may be a virtual reality headset 28 having the display 22 and there may be the step of displaying a virtual reality on the display 22 and the proposed text 23 in the virtual reality. There may be the step of the computer 20 receiving a second finger signal from the sensor 16 which causes the computer 20 to select the desired text 26. There may be the steps of the computer 20 tracking and visualizing a physical keyboard 29 in the virtual reality to facilitate keyboard 29 text 12 entry in virtual reality.

The fingers 14 include eight non-thumb fingers 14 and two thumbs and there may be the step of the computer 20 using finger to letter mapping where each of the 26 letters of the alphabet is mapped to at least one of the eight non-thumb fingers 14, while the two thumbs are reserved for controlling editing functions for word selection, undoing a selection, deletion and cursor navigation, as shown in FIG. 2B. There may be the step of the computer 20 enabling text 12 entry by finger tapping by assigning multiple letters to each finger and showing text 12 suggestions in the display 22 and allowing the user to select desired text 26 via the user's gaze and determine the desired text 26 selection via a thumb tap. There may be the step of the computer 20 displaying a color-coded keyboard 29 layout in the display 22.

The present invention pertains to a non-transitory readable storage medium 30 which includes a computer 20 program 32 stored on the storage medium 30 for entering text 12 by movement of fingers 14 of a user having an eye. The storage medium 30 having the computer-generated steps of associating proposed text 23 from a finger signal obtained from a sensor 16 in communication with at least one finger 18 of the fingers 14 moving. There is the step of displaying on a display 22 the proposed text 23. There is the step of identifying from an eye tracker 24 where the user gazes onto the proposed text 23 displayed on a display 22. There is the step of selecting desired text 26 from the proposed text 23 based on the eye tracker 24 identifying where the eye of the user gazes. The storage medium 30 also may have the computer-generated step of selecting the desired text 26 from a second finger signal from the sensor 16. Alternatively, there may be the step of additional finger taps being used for word disambiguation without an eye tracker 24.

In the operation of the invention, TapGazer was evaluated for seated and standing VR: seated novice users using touchpads as tap surfaces reached 44.81 words per minute (WPM), 79.17% of their QWERTY typing speed. Standing novice users tapped on their thighs with touch-sensitive gloves, reaching 45.26 WPM (71.91%). TapGazer is analyzed and its potential is discussed for text 12 input in AR scenarios.

FIG. 1A shows a physical setup of TapGazer. A VR user enters text 12 without needing to see hands or keyboard 29, by tapping on a surface and resolving ambiguity between candidate words via gaze selection. FIG. 1B shows a visual interface 27 of TapGazer. Fingers 14 are mapped to multiple letters (see colors at bottom-the colors The colors are represented by line hashing according to the standard United States Patent and Trademark Office designations for color, where purple is represented by vertical dashed lines, blue is represented by solid horizontal lines, green is represented by solid downward diagonal lines to the right, yellow is represented by solid crossed horizontal and vertical lines, orange is represented by solid crossed diagonal lines, red or pink is represented by solid vertical lines, brown is represented by solid downward diagonal lines to the left and gray is represented by horizontal dashed lines); the central area shows candidate words corresponding to the current input sequence of finger taps. Users can select a word by gazing at it and tapping the right thumb. FIG. 1C shows a state machine of Tapgazer with gaze selection and word completion.

TapGazer is a novel technique for casual text 12 entry in VR designed to address these challenges by combining finger tapping and eye gaze input (FIGS. 1A-1C). It is envisioned VR users will use TapGazer if they mainly use their hands to interact naturally in VR (without controllers), but need to enter some text 12 quickly from time to time, e.g., to take notes or send text 12 messages. Users type by tapping their fingers 14, without needing to look at their hands or be aware of finger position. The location where a finger is tapped is not needed by TapGazer, therefore taps may be detected with any input device capable of discerning which finger is currently being tapped, e.g., finger-worn accelerometers such as TapStrap, touch-sensitive surfaces such as smart cloth, or visual finger tracking like leap motion. This enables users to quickly move from VR hand interaction to text 12 entry without having to align their fingers 14 on keys, and facilitates use of TapGazer on soft surfaces such as thighs and in different poses such as seating or standing. Tracking fingers' 14 identities and detecting whether a finger has tapped is generally less complicated and more accurate than tracking both the identity and location of each finger, and it is generally easier for users to focus on tapping their fingers 14 without the need to worry about finger location. Given a suitable input device, any available surface may be used to support the hands and facilitate tapping movements, e.g., a table or one's thighs.

To enable text 12 entry by finger tapping, TapGazer simplifies keyboard 29 input by assigning multiple letters to each finger. Because this mapping is one-to-many, it is ambiguous (see the color-coded keyboard 29 layout in FIG. 1(B)). This ambiguity is resolved by showing word suggestions in the users' display 22 and allowing users to select the correct word via gaze and determine the selection via a thumb tap. TapGazer's finger-to-letter mapping is based on a QWERTY keyboard 29 layout, so people can reuse their QWERTY skills and retain the performance benefits of ten-finger typing, which is generally faster than alternatives such as word-gesture keyboards [17]. TapGazer supports the entry of unknown words, symbols, and cursor navigation by allowing users to switch between different modes. Miscellaneous Text Entry Functionality, as more fully described below, is done either by:
1) Tapping chords, i.e., tapping several fingers 14 simultaneously. This is used in particular if an eye gaze tracker is not available.
Or by:
2) Selecting a visual button with gaze and an additional finger tap. One could easily select the button just with gaze, i.e., without a finger tap, or with gaze and several finger taps.

Furthermore, because gaze tracking may not always be available, variants are decribed of TapGazer that work without gaze tracking by allowing users to select target words with additional taps. The following questions are answered:
RQ1 How can text 12 input be efficiently achieved using only finger taps and gaze?
RQ2 How does TapGazer perform in terms of speed, accuracy, and user preference?
RQ3 How is user performance modeled in TapGazer?

These questions are addressed by first discussing the design of TapGazer (RQ1), then reporting on user studies evaluating TapGazer (RQ2) in seated and standing VR scenarios with different tap sensors, and lastly providing a model-based analysis of how different users of TapGazer will likely perform (RQ3).

The performance measured for TapGazer (45.26 WPM on average in a standing VR scenario) compares favorably with those reported for similar works (see Table 1). In summary, the following key contributions are made:
(1) A design that combines tap and gaze for effective text 12 entry in VR, with variants for use without gaze tracking and for accommodating different user preferences.
(2) Evidence that TapGazer is usable and easy-to-learn for novice users, and able to reach average speeds of 44.81 WPM (78.81% of their QWERTY typing speed) using touchpads in a sitting VR scenario (n=14) and 45.26 WPM with word completion (71.91%) using touch-sensitive gloves in a standing VR scenario (n=5).
(3) A model-based performance analysis illustrating the effects of different design options and usage strategies.

TapGazer is based on a reduced QWERTY layout, but it uses different mechanisms for faster disambiguation.

### Gaze-Assisted Text Entry

Text 12 entry with gaze does not require a physical keyboard 29; it is a natural option to consider for VR, which can incorporate gaze tracking. Gaze-only methods mainly fall into four categories [66]: direct gaze pointing with dwell (“gaze typing”), eye switches, discrete gaze gestures, and continuous gaze gestures (“gaze writing”). Dwell [6, 38, 65] (i.e., looking at keys for a certain time to trigger clicks) has been widely applied and optimized to solve the Midas Touch problem [39] (i.e., inadvertent clicks). Approaches for reducing the dwell time necessary for each key have been explored, e.g., by dynamically adjusting it based on prefix [64], word frequency, or character placement [70]; however, it is still a major factor slowing down typing speed. Eye-switch approaches try to avoid dwell by using other operations such as blinking, brow interaction or head movements [29] as triggers. Similarly, discrete gaze gestures have been proposed to avoid dwell, e.g, by adding a resting zone in the typing area [5], ‘swiping’ over a keyboard 29 with gaze to enter a word [16, 48], or using other confirmatory eye movements such as inside-outside-inside saccades [87]. Some disambiguation algorithms have been proposed to improve the accuracy of word-level gaze gestures [56, 77]. Dasher [99] uses continuous gaze gestures to zoom towards and select candidate letters and words.

Some approaches try to speed up gaze-only text 12 entry methods by using other modalities for key and word selection, e.g., a brain computer interface [60], or touch gestures [3, 47]. If gaze tracking is not available, many gaze-based approaches can be modified to use head movement only [104, 110]. This can be combined with other head gestures, e.g., nodding for letter selection [57]. Overall, gaze-based text 12 entry methods facilitate social privacy and can be used while standing or moving in VR [83]; however, they are still much slower than physical keyboards (below 25 WPM) as gaze movements are generally time-consuming [28]. Therefore, TapGazer uses gaze for disambiguation rather than typing.

### Text Entry in VR

Various methods have been investigated for text 12 entry in VR [22]. Because text 12 entry using a physical keyboard 29 is faster than other typing solutions, many approaches for text 12 entry in VR try to facilitate access to a standard physical keyboard 29 rather than replace it. This has mainly been done by tracking and visualizing a physical keyboard 29 in VR while sitting at a desk, either by blending in a video stream showing the real keyboard [11, 41, 55, 69] or by visualizing the keyboard 29 in VR [11, 33, 44, 74, 97]. To support better mobility, HawKEY [80] uses a portable keyboard 29 for users to type on while standing and walking in VR. These approaches show that using a physical keyboard 29 and high-quality tracking can lead to good performance. However, using a physical keyboard 29 can be cumbersome and break immersion when interacting naturally with a virtual environment through body movements, e.g., when standing.

In order to integrate text 12 entry more closely with natural VR interaction, pointing gestures on virtual keyboards have been investigated. Xu et al. [103] and Speicher et al. [92] compared pointing methods to selecting virtual keys with controllers, head, and hand. Boletsis & Kongsvik [10] proposed virtual keyboard layouts to optimize controller-based key selection. PizzaText [112] arranges virtual keys in a circle separated into segments. Didehkhorshid et al. [21] compared controller-based with stylus-based virtual keyboard interaction. Yanagihara et al. [106] introduced a curved virtual QWERTY keyboard, allowing users to use a controller to swipe between different keys. Similarly, Chen et at [17] proposed word gestures by pointing and swiping at a virtual keyboard 29. Additionally, Dube & Arif [23] researched the impact of key design on virtual keyboards for typing speed and accuracy. While these approaches improve mobility, similar to what TapGazer aims to do, they are much slower than physical keyboards, typically below 25 WPM.

Some VR text 12 entry methods use fingers 14 or hands directly. A popular approach is to detect pinch gestures between fingers 14 and thumbs, e.g., using a data glove. Pinch keyboard [12] combines pinch with hand rotation and position to select letters. KITTY [46] uses pinch gestures on different parts of the thumb. PinchType uses a reduced keyboard 29, and if necessary, allows the user to disambiguate words with hand gestures [27]. DigiTouch [101] uses continuous touch position and pressure. Quadmetric [50] and HiFinger [42] support one-handed text 12 entry with pinch. RotoSwype [35] uses one-handed word gestures by rotating a ring worn on one hand. Yu et al. propose one-dimensional ‘handwriting’ of words with a tracked finger or controller [111]. Such pinch and word gesture-based approaches are flexible but slow, with typical speeds far below 20 WPM. Also, mid-air finger gestures can be hard to track and can lead to fatigue when performing longer tasks [2, 24].

Some approaches for eyes-free typing could be feasible for use in VR scenarios although they were not originally designed for VR. BlindType [58] allows users to type without looking at the typing interface 27 using single-thumb touchpad gestures. PalmBoard [107] provides a one-handed touch-typing solution that decodes which keys users likely intend to type on a flat touchpad. Similarly, TOAST [88] leverages statistical decoding algorithms for ten-finger typing on flat touch-sensitive surfaces.

Some approaches use finger touch or taps similar to TapGazer. FaceTouch [34] allows users to type on a touch surface attached to their headset 28. ARKB [51] proposes visual tracking of fingers 14 for tapping on a virtual QWERTY keyboard. VISAR [24] facilitates mid-air one-finger tapping on an AR QWERTY keyboard. VType [26] uses finger tapping on a reduced QWERTY keyboard layout and reconstructs words based on finger sequence, grammar, and context for text 12 input in VR. The accuracy reported for a predefined vocabulary is high; however, no method for disambiguation between candidate words was considered and no typing speed was reported. VType, the 1Line keyboard [54] and the stick keyboard [32], which all involve tapping on a reduced QWERTY keyboard, are the worksclosest to TapGazer. Tapping on a reduced QWERTY keyboard is promising for text 12 entry in VR as it is flexible and robust compared to alternatives. Therefore, we explore how it can be optimized by using gaze input and additional taps for disambiguation.

FIGS. 2A-2F show a TapGazer text 12 entry example. FIG. 2A shows a user is ‘typing’ on her thighs using a TapStrap device instead of a keyboard 29. FIG. 2B shows the user just started to ‘type’ the word “children”. The interface 27 provides optional visualizations of the finger-key mapping as a virtual keyboard 29 and/or hands. FIG. 2C shows the user first tapped the left middle finger (mapped to ‘c’). Then FIG. 2D shows the right index finger (mapped to ‘h’) and FIG. 2E shows the right middle finger (mapped to ‘i’). Finally, FIG. 2F shows the user looks at the word “children”, which gets highlighted with an underline as it is gazed upon, and taps the right thumb to select the highlighted word.

TapGazer allows users to tap words as if they are typing them on a physical QWERTY keyboard 29 and then to disambiguate their tap input by selecting their target word through gaze. It was designed primarily for VR users, but could also be useful for other scenarios where more conventional input devices are unavailable or difficult to access. Given suitable sensors, users can type by tapping their fingers 14 on any surface or even in mid-air. As TapGazer only considers the identity of the finger that is currently tapping and not its position, it only needs to know which of the user's 10 fingers 14 has just been tapped, if any, at any given time. Each of the 26 letters of the alphabet is mapped to at least one of the eight non-thumb fingers 14, while the two thumbs are reserved for controlling editing functions for word selection, undoing a selection, deletion and cursor navigation. FIGS. 1A-1C illustrate the state machine of TapGazer with gaze selection and word completion. Starting from an idle state, TapGazer waits for tap or gaze input events. Except for the thumbs, a finger tap adds a letter to the input string, starting from an empty string. The input string is constructed from an input alphabet with one character for each of the eight fingers 14: the characters asdfjkl are being used; which correspond to the rest positions of each finger on a QWERTY keyboard, for later reference. When typing a word with TapGazer, the user taps the fingers 14 as they would do when typing on a QWERTY keyboard. However, as each finger tap can be interpreted as one of several characters, the word represented by the input is ambiguous: for example, fjd is the input string for the words ‘the’ and ‘bye.’ A set of words that all have the same tapping input string is referred to as a homograph set. A tap with the left thumb deletes the current input string so users can start the word again. A tap of the right thumb selects the word to enter from a list of suggestions while the word is pointed at by the user's gaze.

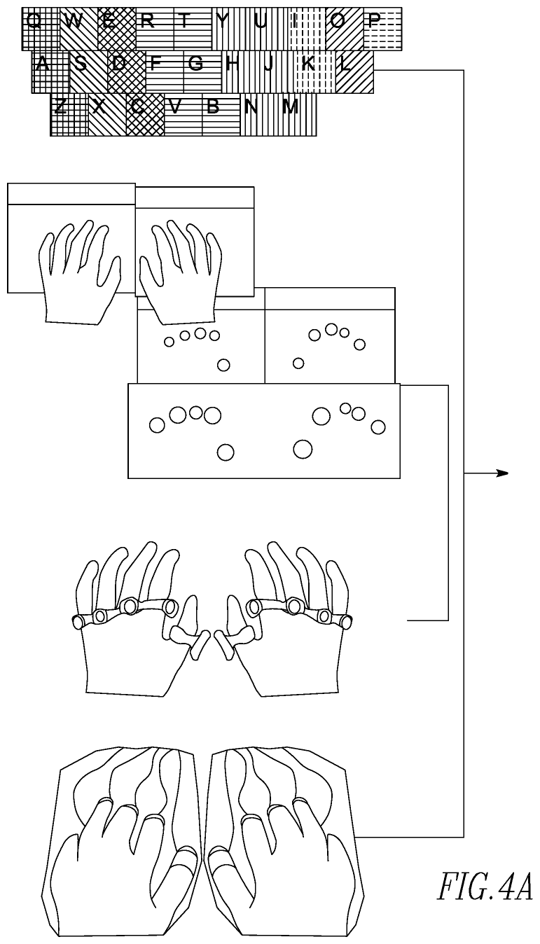

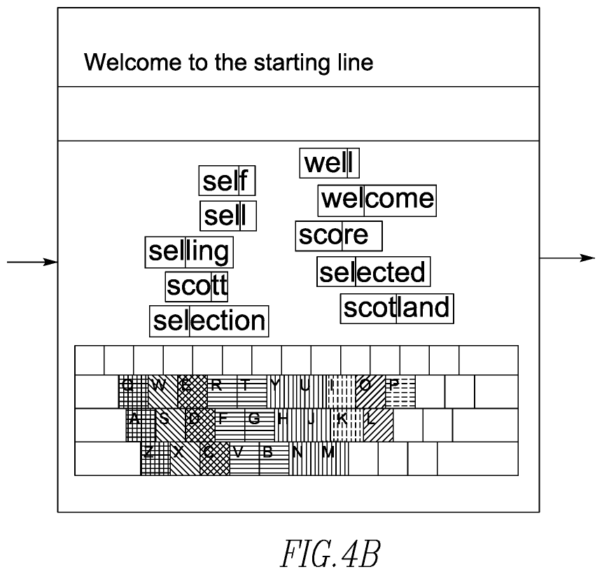

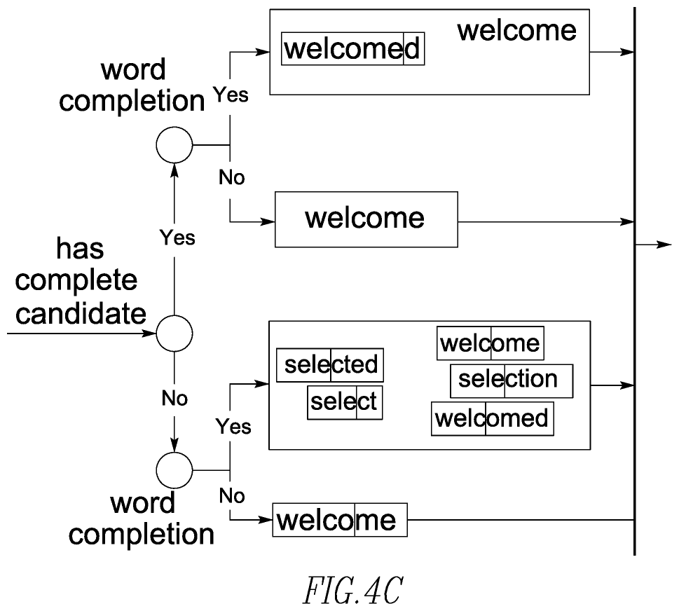

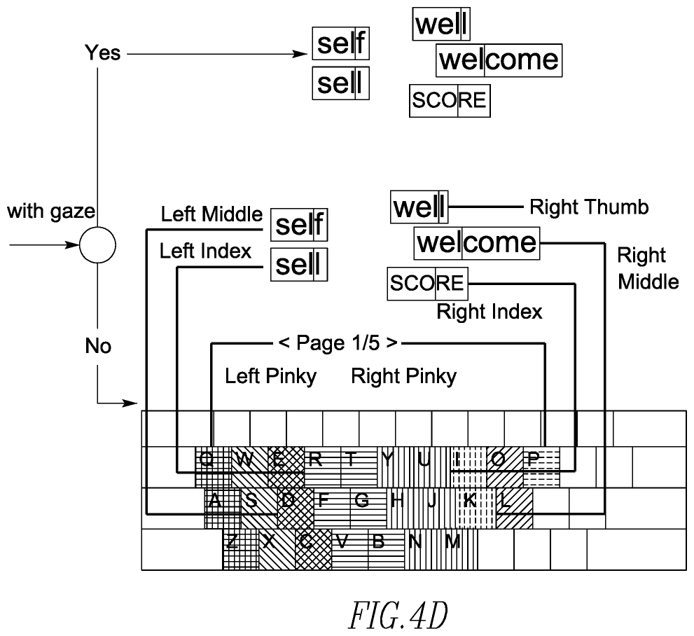

As a user enters an input string, the central area of TapGazer's user interface 27 shows a list of word candidates: similar to predictive text 12 on a mobile phone, the user is given a list of the most likely words to choose from. TapGazer shows all words in the homograph set for the given input string, which are called complete candidates as they are based on the whole input string (e.g., ‘the’ for fjd). Additionally, TapGazer uses a language model to show the most likely incomplete candidates, i.e., words with a prefix matching the current input string (e.g., ‘these’ for fjd). After each tap, TapGazer updates the candidates shown. In order to select a candidate, the user looks at it, and in response, the fixated candidate is highlighted with an underline. If the right thumb is tapped, the currently highlighted candidate is selected and added to the entered text 12. At this point, the TapGazer state machine starts again with an empty input string. If the user taps the right thumb but does not fixate any candidate, then the most likely candidate is selected based on a language model. FIGS. 2A-2F illustrate how to type ‘children’ with TapGazer. Word completion in TapGazer can be disabled; in this variant, only complete candidates are shown if they exist. If no complete candidate exists, the shortest incomplete candidate is shown to inform users about the progress of typing. Furthermore, a purely manual variant of TapGazer without gaze tracking has been designed, allowing users to disambiguate candidates with extra taps. FIG. 4 illustrates different input devices (left) and variants (as decision nodes in the state machine) of Tapgazer.

Several design decisions were made: First, finger tapping was used so that users can ‘type’ on any surface and require no context knowledge between the surface location and finger/hand location. Second, users are helped to find the word to type in the list of candidates by facilitating visual search in the layout of the graphical interface 27. Third, word completion is provided and compare whether word completion benefits TapGazer in terms of performance.

### Virtual Keyboard Layout

Customization. TapGazer reuses the standard QWERTY layout to support learnability. However, in studies, it was found people had varying finger preferences for typing on the QWERTY keyboard, e.g., key ‘m’ may be pressed with either the right index finger or the right middle finger. The mappings were consistent, i.e., remained overall stable for each user. As a result, TapGazer creates a profile for each user to record their finger-to-key mapping, also allowing users to map multiple fingers 14 to the same letter (e.g., ‘y’ could be triggered by both the left and right index fingers 14). To guide novice users, the customized finger-to-key mapping is optionally visualized in a virtual keyboard and/or a hand model (FIG. 2B), with each key colored according to its associated fingers 14 and letters rendered on their corresponding fingers 14. Based on users' mappings, prefix trees are generated to quickly look up complete and incomplete candidate words and their word frequencies for each input string.

Feasibility. Text 12 entry is only feasible if all the words in the homograph set of any input string can be somehow selected. The minimum candidate number (MCN) is the minimum number of candidate words the interface 27 must be able to disambiguate at a time. It is equal to the maximum number of homographs an input string can have, i.e., it describes the worst possible ambiguity that may need to be resolved. The design needs to determine the MCN in advance because display 22 space needs to be adequately allocated, or users must be given the option to page through sets of candidates. The MCN is also relevant for performance as it describes the worst-case scenario of visual search for the right candidate. Popular QWERTY-based finger-to-key mappings were determined in pilot experiments and then a simulation was run to determine their overall MCN based on different word sources: the 1000 most common words (“1K”) retrieved from Wikipedia with MCN1K=4; the standard MacKenzie phrase corpus [62], which contains 500 phrases for evaluation use, with MCNMacKenzie=6; and the 90% most frequent words (7,440, “7K”) generated from the wordfreq library [1], which includes many very-low-frequency specialized words and acronyms that are not typically part of dictionaries, with MCN7K=7. The interface 27 was designed to be able to show at least 10 candidates to cover all English dictionary words and also many low-frequency non-dictionary words across typical QWERTY finger-to-key mappings. For unsupported words such as neologisms and special acronyms, a spelling mode for character-level text 12 entry is provided below.

Alternative Layouts. The MCNs of standard keyboard layouts were also calculated other than QWERTY to gauge their suitability for use in TapGazer. Optimal word gesture keyboards such as Smith et al.'s GK-D (MCNMacKenzie=11, MCN7K=12) and GK-T (MCNMacKenzie=7, MCN7K=17) [90] have higher MCNs, probably because they are not optimized for key-based typing. If the left thumb is used for tapping instead of deletion (e.g. by triggering deletion with a chord), having 9 fingers 14 to tap reduces ambiguity in the finger-to-key assignment, potentially decreasing the MCN. The MCN for some known 9-key layouts was calculated: standard T9 [102] (MCNMacKenzie=MCN7K=5); HiFinger [42], which distributes letters in lexical order over nine keys (MCNMacKenzie=5, MCN7K=8); and the quadmetric optimized layout [50] (MCNMacKenzie=MCN7K=4). Finally, an extensive combinatorial search of non-QWERTY layouts was performed and found that there is a very large number of mappings for eight fingers 14 with MCNMacKenzie=MCN7K=4. These results suggest that layout optimization can help to reduce the number of candidates that have to be shown at one time, which could speed up text 12 input.

FIGS. 3A-3D show the Evolution of TapGazer candidate layout designs. FIG. 3A shows a Lexical Layout which places the most common candidate word in the first row and arranges the other candidates in alphabetical order. All the candidates have the same font size. FIG. 3B shows a WordCloud Layout which emphasizes frequent candidates with a larger font size. Candidates that were already shown on the previous tap keep their position. FIG. 3C shows a Division Layout which divides all candidates into three columns according to their last letter. FIG. 3D shows a Pentagon Layout orders the candidates based on the frequency and arranges the candidates in a compact single or double pentagon shape, separating them for easier gaze selection.

The most important part of TapGazer's visual interface 27 is the central gray area where word candidates are shown for selection by the user (FIG. 2B). These candidates are colored to indicate the tapping progress of each word: the prefix of each word that has already been tapped is colored in blue, while yet-to-be-tapped postfixes are colored in orange. Complete candidates are completely blue and are always shown in the interface 27 as they must be available as word choices. Any further available space can be filled with incomplete candidates, indicating options for word completion. The number of candidates shown is a trade-off between saving taps through word completion, and visual search time spent looking for the right candidate. Visual search time is affected by the way the candidates are arranged, therefore the layout was designed, tested, and re-designed to reach a suitable design. FIGS. 3A-3D illustrate the design evolution of TapGazer's candidate layout.

Initial Design. (A) Lexical Layout and (b) WordCloud Layout were designed based on the following design principles. Systematic locations: Users should intuitively know where to look for a word. Salience: More likely words should be more salient (e.g., larger or more central). Continuity: Avoiding changes in the position of a suggested word between taps may help users to spot it. Lexical Layout places the most frequent word into the first row by itself for salience, and fills the rows below with other candidates in alphabetical order to achieve systematic locations. This prioritizes systematic locations over continuity, as candidates' positions may change between taps, e.g., “welcome” in FIGS. 3A-3C. WordCloud Layout arranges candidates in word-cloud style, with more frequent words arranged at the center and in a larger font. Candidates keep their positions between taps, prioritizing continuity over systematic locations. Both layouts use only the central part of the VR display 22 to avoid large eye movements.

Formative Design Study. To understand the effects of the layouts and their design principles on novices, a formative study was conducted with 12 participants (5 female, 7 male; aged 18 to 30, M=24.67, SD=3.94), comparing the two layouts which were implemented in Unity in a within-participant design. After a 5-minute training phase, each participant used each layout twice for 5 minutes each, with a small break in between, to enter random sentences from the MacKenzie corpus [62] as quickly and accurately as possible. Wearing a Tobii HTC VIVE Devkit gaze tracking VR headset 28, they tapped on a QWERTY keyboard, keeping their fingers 14 on the same keys for tapping. To investigate the effects of a different input device, participants then repeated the task with the TapStrap using only their preferred layout. Each condition was followed by quantitative and qualitative questionnaires collecting their feedback on each layout, design principle and input device.

Paired t-tests showed no significant differences in typing speed (t(11)=0.897,p=0.389, Cohen's d=0.259), accuracy in terms of Total Error Rate (TER) [91] (t(11)=0.099,p=0.923,d=0.029), System Usability Scale (SUS) scores [4] (t(11)=1.081,p=0.202,d=0.312), or NASA-TLX task load scores [37] (t(11)=1.307,p=0.218,d=377). Participants were split equally in their layout preference. Their qualitative responses showed that they immediately understood Lexical layout's systematic locations but did not find them helpful in spotting target words quickly. Having the most frequent word at the top or center was found useful, but variations in font size were found to be distracting when typing low-frequency words (“words with larger font size draw too much attention and it became difficult to locate the infrequent words”). Some participants noticed WordCloud's continuity but did not find it beneficial (“confusing”) as tapping was too fast to visually follow candidates.

In conclusion, the most important finding was that it is not preferred to design the visual layout around the tapping process or around cognitively demanding criteria such as relative alphabetic ordering, as fingers 14 are much faster than the eye or the mind [82]. It is more useful to consider the layout as a pure visual search task, where visual search time is correlated with the number of candidates and the distance of eye movement [72]. The study also highlights the importance of the tap input device: leaving the fingers 14 on the same keys for tapping felt unnatural and slowed them down considerably (on average 15.37 WPM for Lexical and 14.34 WPM for WordCloud); participants liked the idea of TapStrap but were frustrated and slowed down by its low tap recognition rates (on average 9.89 WPM; TER of 0.34 vs. 0.15 for Lexical and 0.14 for WordCloud).

Final Designs. Based on the formative study, two new layouts were developed that focus on optimizing visual search by reducing distances between words, improving salience of frequent words, dropping the continuity principle, and applying the principle of the systematic location more carefully to avoid cognitive load: one layout for power users and one for novices. Division Layout (FIG. 3C) distributes candidates into three columns according to their last letter, ordering each column by word frequency. The column boundaries were chosen to balance the expected number of candidates in each column, with words ending in A-E on the left, F-R in the middle, and S-Z on the right. This layout is designed for power users who have learned where to expect a word, potentially reducing search time by ⅔. It was found from testing over several days that with practice, the eyes would subliminally move to the right column when tapping frequent words. Pentagon Layout (d) is designed to be suitable both for novices and experts. It arranges candidates in compact groups of five, close together to minimize eye movement but with enough separation for accurate gaze selection (at least 0.5° visual angle between the edge of two neighbor words, which typically leads to considerably more separation between the center of any two words and enabled accurate selection in our pilot studies). The pentagon shapes mitigate overlap between long adjacent words and try to take advantage of people's ability to quickly scan groups of five items at a time [68]. Complete candidates are always shown before incomplete candidates, with frequent words closer to the top.

The two new layouts were delivered to a group of users remotely for subjective feedback. Most participants believed both layouts could facilitate fast typing given enough practice. However, they preferred the Pentagon layout because it was more compact (less “sprawling” and “confusing”) and more straightforward and intuitive to search since they would usually scan for the word to type downwards one by one (“from the top”). Thus, Pentagon Layout was chosen for the main study as it is easier to use for non-experts.

FIG. 4 shows the TapGazer's workflow: After receiving a tap from a suitable input device, TapGazer updates the candidates according to the word completion mode, and allows users to select a candidate either with gaze or with additional taps.

After presenting possible word candidates, users need to select a candidate to disambiguate the input. In text 12 entry on mobile devices where word candidates are commonly selected by touch, users typically fixate on a candidate with their eyes right before and while selecting it [100], and similar gaze behavior can be observed for pointer-based selection [8]. TapGazer takes advantage of these quick, subliminal fixations by employing gaze tracking for word selection to minimize taps and reduce cognitive load. Once the user has found the right word and is looking at it, the user can select it with a tap of the right thumb. A tap was chosen to be used rather than a gaze-dwell for selection as the latter is much more time-consuming and can lead to Midas Touch (inadvertent activations) [78]. Gaze selection implementation was tested with an HTC Vive Tobii DevKit for VR users and also a Tobii 5 tracker bar for non-VR users (both of which are existing commercially available systems to do the gaze tracking; the former being a VR headset 28 having eye tracking for VR users and the latter for non-VR users), showing a small transparent circle as gaze indicator to give users feedback about gaze tracking. Pilot user feedback showed that, based on the estimated gaze coordinates, it was possible to determined which candidate word was being gazed at.

In the absence of gaze tracking, a variant of TapGazer was provided with purely manual selection (FIG. 4 bottom-right). In this variant, selecting a candidate is a two-step operation: 1) tapping with the right thumb, and 2) tapping with one of five fingers 14 (right thumb, right middle, right index, left middle, left index) to select one among a maximum of five candidates shown. To support selection from more than five candidates, users can page through sets of five candidates with their left and right little fingers 14. The layout design helps to avoid paging operations by showing complete candidates first and ordering complete and incomplete candidates by their descending word frequencies.

Impact Study for Manual Selection. To understand how manual selection impacts TapGazer, a study was conducted with 20 participants (3 female and 17 male; aged 24 to 35, M=28.25, SD=3.45) using a within-participant design. The study was conducted remotely because of COVID restrictions, so participants used their personal computers without VR headset 28 or gaze tracker. Participants were sent a Unity executable and completed the same procedure as in the formative design study (subsection 3.2) except that they were allowed to ‘tap’ using their whole keyboard (i.e., type as usual). Manual selection was compared with simulated gaze selection, i.e., the prototype assumes the user gazed on the correct word when selecting a candidate. To mitigate the bias of simulated gaze, it was impressed on the participants the importance of locating the right candidates with their eyes before selecting them with a key tap.

Paired t-tests showed that selection with simulated gaze was significantly faster than manual selection (average 51.84 vs. 36.85 WPM, t(19)=9.697,p<0.001***,d=2.168), with significantly higher SUS scores (77.00 vs. 60.63, t(19)=4.052,p<0.001***,d=0.906). The differences in TER (0.040 vs. 0.046, t(19)=1.422,p=0.171,d=0.318) and TLX scores (36.94 vs. 54.14, t(19)=1.990, p=0.061, d=0.445) were not significant. Participants were able to reach 76% and 54% of their QWERTY typing speed, respectively. This setup favoured gaze selection because simulated gaze tracking does not suffer from tracking inaccuracy and selection mistakes, hence the results arguably estimate an upper bound for the impact of manual selection. While the reduction in performance is marked, the results indicate that manual selection is possible with a reasonable performance, and that users are able to learn it quickly.

### Miscellaneous Text Entry Functionality

Miscellaneous text 12 editing functions were designed for TapGazer in order to make it a complete text 12 entry method. Deletion of the current input string is performed by tapping the left thumb, allowing users to start a word again. If the left thumb is pressed right after selecting a candidate, the candidates for the last input string will be shown again, allowing users to change the selection or tap the left thumb again to delete the word. Spelling mode is triggered with a chord operation. Users can switch between word-level and character-level text 12 entry by tapping their left and right index fingers 14 simultaneously. Afterward, users can rotate through the characters mapped to each finger by repeatedly tapping a respective finger, and enter the character by tapping the right thumb. Tapping the right thumb again concludes the character-level input. Cursor navigation with gaze is performed by selecting words in the entered text 12 directly with gaze and right thumb [89], or by entering a cursor navigation mode through a button in the periphery of the interface [59] with gaze and right thumb. Users can then move the cursor by tapping the left/right index finger and exit cursor mode with a right thumb tap. If the gaze is unavailable, users can enter cursor mode by tapping the right index and ring fingers 14 simultaneously.

### Input Devices

TapGazer was tested with several off-the-shelf input devices (FIG. 4 left): 1) QWERTY keyboards are partitioned into areas that are each mapped to one finger 18. This partitioning is consistent with a user's usual finger-to-key mapping, so the user can retain their QWERTY skills. 2) Touchpads (Sensel Morph) report pressure images of fingers 14 for every frame. The hand directions were detected (left and right hand) and identify fingers 14 based on the shape and configuration of recent pressure points. Users can calibrate the finger detection at any time by placing all fingers 14 onto the touchpad. In pilot studies it was estimated the accuracy of finger detection on Sensel Morph touchpads at 99.86%. 3) Wearable devices such as TapStrap can report tapping information through Bluetooth. In addition to TapStrap, which had a comparatively poor accuracy, a pair of touch-sensitive gloves were also designed that report taps with finger identities (FIG. 4 bottom left). A pair of cotton gloves were connected to an Arduino UNO board through wires with conductive foil tape around each finger, and used foil tape on hard and soft surfaces such as tabletops and things to detect taps based on electric currents. In pilot studies it was estimated the accuracy of the gloves at close to 100%.

All TapGazer were built in Unity, using the Pentagon layout. Participants wore a Tobii HTC VIVE Devkit HMD with gaze tracking connected to a windows laptop (Intel Core i7, NVidia GeForce RTX 2070) in the TapGazer conditions.

### REFERENCES, ALL OF WHICH ARE INCORPORATED BY REFERENCE HEREIN

[1] 2. LuminosoInsight/wordfreq: V2.2. https://doi.org/10.5281/zenodo.1443582
[2] Jiban Adhikary. 2018. Text Entry in VR and Introducing Speech and Gestures in VR Text Entry. In MobileHCI. Association for Computing Machinery, Barcelona, Spain, 1083-1092. https://doi.org/10.20870/IJVR.2019.19.3.2917
[3] Sunggeun Ahn and Geehyuk Lee. 2019. Gaze-Assisted Typing for Smart Glasses. In Proceedings of the 32nd Annual ACM Symposium on User Interface Software and Technology. 857-869. https://doi.org/10.1145/3332165.3347883
[4] Aaron Bangor, Philip T Kortum, and James T Miller. 2008. An Empirical Evaluation of the System Usability Scale. Intl. Journal of Human-Computer Interaction 24, 6 (2008), 574-594. https://doi.org/10.1080/10447310802205776
[5] Nikolaus Bee and Elisabeth André. 2008. Writing With Your Eye: a Dwell Time Free Writing System Adapted to the Nature of Human Eye Gaze. In International Tutorial and Research Workshop on Perception and Interactive Technologies for Speech-Based Systems. Springer, Springer, 111-122. https://doi.org/10.1007/978
[6] Burak Benligiray, Cihan Topal, and Cuneyt Akinlar. 2019. SliceType: Fast Gaze Typing With a Merging Keyboard. Journal on Multimodal User Interfaces 13, 4 (2019), 321-334. https://doi.org/10.1007/s12193-018-0285-z
[7] Xiaojun Bi, Barton A Smith, and Shumin Zhai. 2010. Quasi-Qwerty Soft Keyboard Optimization. In Proceedings of the SIGCHI Conference on Human Factors in Computing Systems. 283-286. https://doi.org/pdf/10.1145/1753326.1753367
[8] Hans-Joachim Bieg, Lewis L Chuang, Roland W Fleming, Harald Reiterer, and Heinrich H Bülthof. 2010. Eye and pointer coordination in search and selection tasks. In Proceedings of the 2010 Symposium on Eye-Tracking Research & Applications. 89-92.
[9] Gaddi Blumrosen, Katsuyuki Sakuma, John Jeremy Rice, and John Knickerbocker. 2020. Back to Finger-Writing: Fingertip Writing Technology Based on Pressure Sensing. IEEE Access 8 (2020), 35455-35468. https://doi.org/10.1109/ACCESS. 2020.2973378
[10] Costas Boletsis and Stian Kongsvik. 2019. Controller-Based Text-Input Techniques for Virtual Reality: an Empirical Comparison. International Journal of Virtual Reality 19, 3 (2019), 2-15.
[11] Sidney Bovet, Aidan Kehoe, Katie Crowley, Noirin Curran, Mario Gutierrez, Mathieu Meisser, Damien O Sullivan, and Thomas Rouvinez. 2018. Using Traditional Keyboards in VR: SteamVR Developer Kit and Pilot Game User Study. In 2018 IEEE Games, Entertainment, Media Conference (GEM). IEEE, IEEE, 1-9. https://doi.org/10.1109/GEM.2018.8516449
[12] Doug Bowman, Vinh Ly, Joshua Campbell, and Virginia Tech. 2001. Pinch Keyboard: Natural Text Input for Immersive Virtual Environments. (01 2001). https://doi.org/10.1007/978-3-642-24082-94
[13] Damien Brun, Charles Gouin-Vallerand, and Sébastien George. 2019. Keycube Is a Kind of Keyboard (k3). In Extended Abstracts of the 2019 CHI Conference on Human Factors in Computing Systems. 1-4. https://doi.org/fullHtml/10.1145/3290607.3313258
[14] Stuart K Card, Thomas P Moran, and Allen Newell. 1980. The Keystroke-Level Model for User Performance Time With Interactive Systems. Commun. ACM 23, 7 (1980), 396-410. https://doi.org/10.1145/358886.358895
[15] Steven J Castellucci, I Scott MacKenzie, Mudit Misra, Laxmi Pandey, and Ahmed Sabbir Arif. 2019. TiltWriter: Design and Evaluation of a No-Touch Tilt-Based Text Entry Method for Handheld Devices. In Proceedings of the 18th International Conference on Mobile and Ubiquitous Multimedia. 1-8. https://doi.org/10.1145/3365610.3365629
[16] Morokot Cheat and Manop Wongsaisuwan. 2018. Eye-Swipe Typing Using Integration of Dwell-Time and Dwell-Free Method. IEEE, IEEE, 205-208. https://doi.org/10.1109/ECTICon.2018.8619868
[17] Sibo Chen, Junce Wang, Santiago Guerra, Neha Mittal, and Soravis Prakkamakul. 2019. Exploring Word-Gesture Text Entry Techniques in Virtual Reality. In Extended Abstracts of the 2019 CHI Conference on Human Factors in Computing Systems. 1-6. https://doi.org/10.1145/3290607.3312762
[18] Jacob Cohen. 1992. A Power Primer, Psychological Bulletin 112,1 (1992), 155. https://doi.org/70039-power-primer-summary-article-cohen-1992[19] Gennaro Costagliola, Vittorio Fuccella, and Michele Di Capua. 2011. Text Entry With Keyscretch. In Proceedings of the 16th International Conference on Intelligent User Interfaces. 277-286. https://doi.org/10.1145/1943403.1943445
[20] Wenzhe Cui, Suwen Zhu, Mingrui Ray Zhang. H Andrew Schwartz, Jacob O Wobbrock, and Xiaojun Bi. 2020. JustCorrect: Intelligent Post Hoe Text Correction Techniques on Smartphones. In Proceedings of the 33rd Annual ACM Symposium on User Interface Software and Technology. 487-499. https://doi.org/10.1145/3379337.3415857
[21] Seyed Amir Ahmad Didehkhorshid, Siju Philip, Elaheh Samimi, and Robert J Teather. 2020. Text Input in Virtual Reality Using a Tracked Drawing Tablet. In International Conference on Human-Computer Interaction. Springer, 314-329.
[22] Tafadzwa Joseph Dube and Ahmed Sabbir Arif 2019. Text Entry in Virtual Reality: a Comprehensive Review of the Literature. In International Conference on Human-Computer Interaction. Springer, Springer, 419-437. https://doi.org/0.1145/3359996.3364265
[23] Tafadzwa Joseph Dube and Ahmed Sabbir Arif. 2020. Impact of Key Shape and Dimension on Text Entry in Virtual Reality. In Extended Abstracts of the 2020 CHI Conference on Human Factors in Computing Systems. 1-10. https://doi.org/pdf/10.1145/3334480.3382882
[24] John J Dudley, Keith Vertanen, and Per Ola Kristensson. 2018. Fast and Precise Touch-Based Text Entry for Head-Mounted Augmented Reality With Variable Occlusion. ACM Transactions on Computer-Human Interaction (TOCHI) 25, 6 (2018), 1-40. https://doi.org/10.1145/3232163
[25] Mark D Dunlop, Naveen Durga, Sunil Motaparti, Prima Dona, and Varun Medapuram. 2012. QWERTH: an Optimized Semi-Ambiguous Keyboard Design. In Proceedings of the 14th International Conference on Human-Computer Interaction With Mobile Devices and Services Companion. 23-28. https://doi.org/pdf/10.1145/2371664.2371671
[26] Francine Evans, Steven Skiena, and Amitabh Varshney. 1999. VType: Entering Text in a Virtual World. Submitted to International Journal of Human-Computer Studies (1999). https://doi.org/10.1145/1044588.1044662[27] Jacqui Fashimpaur, Kenrick Kin, and Matt Longest. 2020. PinchType: Text Entry for Virtual and Augmented Reality Using Comfortable Thumb to Fingertip Pinches. In Extended Abstracts of the 2020 CHI Conference on Human Factors in Computing Systems Extended Abstracts. 1-7. https://doi.org/10.1145/3334480.3382888
[28] John M Findlay. 1997. Saccade Target Selection During Visual Search. Vision Research 37, 5 (1997), 617-631.
[29] Yulia Gizatdinova, Oleg S̆pakov, and Veikko Surakka. 2012. Comparison of Video-Based Pointing and Selection Techniques for Hands-Free Text Entry. In Proceedings of the International Working Conference on Advanced Visual Interfaces. 132-139. https://doi.org/pdf/10.1145/2254556.2254582
[30] Jun Gong, Zheer Xu, Qifan Guo, Teddy Seyed, Xiang‘Anthony’ Chen. Xiaojun Bi, and Xing-Dong Yang. 2018. Wristext: One-Handed Text Entry on Smartwatch Using Wrist Gestures. In Proceedings of the 2018 CHI Conference on Human Factors in Computing Systems. 1-14. https://doi.org/10.1145/3173574.3173755
[31] Joshua Goodman, Gina Venolia. Keith Steury, and Chauncey Parker. 2002. Language Modeling for Soft Keyboards. In Proceedings of the 7th International Conference on Intelligent User Interfaces. 194-195. https://doi.org/10.1145/502716.502753
[32] Nathan Green, Jan Kruger, Chirag Faldu, and Robert St. Amant. 2004. A Reduced QWERTY Keyboard for Mobile Text Entry. In CHI'04 Extended Abstracts on Human Factors in Computing Systems. 1429-1432. https://doi.org/pdf/10.1145/985921.986082
[33] Jens Grubert, Lukas Witzani, Eyal Ofek, Michel Pahud, Matthias Kranz, and Per Ola Kristensson. 2018. Text Entry in Immersive Head-Mounted DisplayBased Virtual Reality Using Standard Keyboards. In 2018 IEEE Conference on Virtual Reality and 3D User Interfaces (VR). IEEE, IEEE, 159-166. https://doi.org/10.1109/VR.2018.8446059
[34] Jan Gugenheimer, David Dobbelstein, Christian Winkler, Gabriel Haas, and Enrico Rukzio. 2016. Facetouch: Enabling Touch Interaction in Display Fixed Uis for Mobile Virtual Reality. In Proceedings of the 29th Annual Symposium on User Interface Software and Technology. 49-60. https://doi.org/10.1145/2984511_2984576
[35] Aakar Gupta, Cheng Ji, Hui-Shyong Yeo, Aaron Quigley, and Daniel Vogel. 2019. RotoSwype: Word-Gesture Typing Using a Ring. In Proceedings of the 2019 CHI Conference on Human Factors in Computing Systems. 1-12. https://doi.org/10.1145/3290605.3300244
[36] Shangchen Han, Beibei Liu, Robert Wang, Yuting Ye, Christopher D Twigg, and Kenrick Kin. 2018. Online Optical Marker-Based Hand Tracking With Deep Labels. ACM Transactions on Graphics (TOG) 37, 4 (2018), 1-10. https://doi.org/10.1145/3197517.3201399
[37] Sandra G Hart. 2006. NASA-Task Load Index (NASA-TLX); 20 Years Later. In Proceedings of the Human Factors and Ergonomics Society Annual Meeting, Vol. 50. Sage publications Sage CA: Los Angeles, CA, Sage publications Sage CA: Los Angeles, CA, 904-908.
[38] Anke Huckauf and Mario H Urbina. 2008. Gazing With PEYEs: Towards a Universal Input for Various Applications. In Proceedings of the 2008 Symposium on Eye Tracking Research & Applications. 51-54. https://doi.org/10.1145/1344471.1344483
[39] Robert J K Jacob. 1993. Eye Movement-Based Human-Computer Interaction Techniques: Toward Non-Command Interfaces. Advances in Human-Computer Interaction 4 (1993), 151-190. https://doi.org/11.1145/332040.332445
[40] Haiyan Jiang and Dongdong Weng. 2020. HiPad: Text Entry for Head-Mounted Displays Using Circular Touchpad. In 2020 IEEE Conference on Virtual Reality and 3D User Interfaces (VR). IEEE, IEEE, 692-703. https://doi.org/10.1109/VR46266.2020.00092
[41] Haiyan Jiang, Dongdong Weng, Zhenliang Zhang, Yihua Bao, Yufei Jia, and Mengman Nie. 2018. HiKeyb: High-Efciency Mixed Reality System for Text Entry. In 2018 IEEE International Symposium on Mixed and Augmented Reality Adjunct (ISMAR-Adjunct). IEEE, IEEE, 132-137. https://doi.org/10.1109/ISMARAdjunct.2018.00051
[42] Haiyan Jiang, Dongdong Weng, Zhenliang Zhang. and Feng Chen. 2019. HiFinger: One-Handed Text Entry Technique for Virtual Environments Based on Touches Between Fingers 14. Sensors 19, 14 (2019), 3063. https://doi.org/10.3390/s19143063
[43] Sunjun Kim, Jeongmin Son, Geehyuk Lee, Hwan Kim, and Woohun Lee. 2013. TapBoard: Making a Touch Screen Keyboard More Touchable. In Proceedings of the SIGCHI Conference on Human Factors in Computing Systems. 553-562. https://doi.org/10.1145/2470654.2470733
[44] Pascal Knierim, Valentin Schwind, Anna Maria Feit, Florian Nieuwenhuizen, and Niels Henze. 2018. Physical Keyboards in Virtual Reality: Analysis of Typing Performance and Efects of Avatar Hands. In Proceedings of the 2018 CHI Conference on Human Factors in Computing Systems. 1-9. https://doi.org/10.1145/3173574.3173919
[45] Per-Ola Kristensson and Shumin Zhai, 2004. SHARK2: a Large Vocabulary Shorthand Writing System for Pen-Based Computers. In Proceedings of the 17th Annual ACM Symposium on User Interface Software and Technology. 43 52. https://doi.org/10.1145/1029632.1029640
[46] Falko Kucster, Michelle Chen, Mark E Phair, and Carsten Mehring. 2005. Towards Keyboard Independent Touch Typing in VR. In Proceedings of the ACM Symposium on Virtual Reality Software and Technology. 86-95. https://doi.org/10.1145/1101616.1101635
[47] Chandan Kumar, Ramin Hedeshy, Scott MacKenzie, and Stefen Staab. 2020. TAGSwipe: Touch Assisted Gaze Swipe for Text Entry. (2020). https://doi.org/abs/10.1145/3313831.3376317
[48] Andrew Kurauchi, Wenxin Feng, Ajjen Joshi, Carlos Morimoto, and Margrit Betke. 2016. EyeSwipe: Dwell-Free Text Entry Using Gaze Paths. 1952-1956. https://doi.org/10.1145/2858036.2858335
[49] Andrew Toshiaki Nakayama Kurauchi. 2018. EyeSwipe: Text Entry Using Gaze Paths. Ph.D. Dissertation. Universidade de São Paulo.
[50] Lik Hang Lee, Kit Yung Lam, Tong Li, Tristan Braud, Xiang Su, and Pan Hui. 2019. Quadmetric Optimized Thumb-to-Finger Interaction for Force Assisted OneHanded Text Entry on Mobile Headsets. Proceedings of the ACM on Interactive, Mobile, Wearable and Ubiquitous Technologies 3, 3 (2019), 1-27. https://doi.org/10.1145/3351252
[51] Minkyung Lee, Woontack Woo, et al. 2003. ARKB: 3D Vision-Based Augmented Reality Keyboard. In ICAT. https://doi.org/10.7537/marslsj1010s13.45
[52] Seongil Lee, Sang Hyuk Hong, and Jae Wook Jeon. 2002. Designing a Universal Keyboard Using Chording Gloves. ACM SIGCAPH Computers and the Physically Handicapped 73-74 (2002), 142-147. https://doi.org/abs/10.1145/960201.957230
[53] Luis A Leiva, Alireza Sahami, Alejandro Catala, Niels Henze, and Albrecht Schmidt. 2015. Text entry on tiny qwerty soft keyboards. In Proceedings of the 33rd Annual ACM Conference on Human Factors in Computing Systems. 669-678.
[54] Frank Chun Yat Li, Richard T Guy, Koji Yatani, and Khai N Truong. 2011. The 1line Keyboard: a QWERTY Layout in a Single Line. In Proceedings of the 24th Annual ACM Symposium on User Interface Software and Technology. 461-470. https://doi.org/10.1145/2047196.2047257
[55] Jia-Wei Lin, Ping-Hsuan Han, Jiun-Yu Lee, Yang-Sheng Chen, Ting-Wei Chang, Kuan-Wen Chen, and Yi-Ping Hung. 2017. Visualizing the Keyboard in Virtual Reality for Enhancing Immersive Experience. In ACM SIGGRAPH 2017 Posters. 1-2. https://doi.org/10.1145/3102163.3102175
[56] Yi Liu, Chi Zhang, Chonho Lee, Bu-Sung Lee, and Alex Qiang Chen. 2015. Gazetry: Swipe Text Typing Using Gaze. In Proceedings of the Annual Meeting of the Australian Special Interest Group for Computer Human Interaction. 192-196. https://doi.org/10.1145/2838739.2838804
[57] Xueshi Lu, Difeng Yu, Hai-Ning Liang, Xiyu Feng, and Wenge Xu. 2019. DepthText: Leveraging Head Movements Towards the Depth Dimension for Hands-Free Text Entry in Mobile Virtual Reality Systems. In 2019 IEEE Conference on Virtual Reality and 3D User Interfaces (VR). IEEE, IEEE, 1060-1061. https://doi.org/10.1109/VR.2019.8797901
[58] Yiqin Lu, Chun Yu, Xin Yi, Yuanchun Shi, and Shengdong Zhao. 2017. Blindtype: Eyes-Free Text Entry on Handheld Touchpad by Leveraging Thumb's Muscle Memory. Proceedings of the ACM on Interactive, Mobile, Wearable and Ubiquitous Technologies 1, 2 (2017), 1-24. https://doi.org/10.1145/3090083
[59] Christof Lutteroth, Moiz Penkar, and Gerald Weber. 2015. Gaze vs. Mouse: a Fast and Accurate Gaze-Only Click Alternative. In Proceedings of the 28th Annual ACM Symposium on User Interface Software & Technology. 385-394. https://doi.org/10.1145/2807442.2807461
[60] Xinyao Ma, Zhaolin Yao, Yijun Wang, Weihua Pei, and Hongda Chen. 2018. Combining Brain-Computer Interface and Eye Tracking for High-Speed Text Entry in Virtual Reality. In 23rd International Conference on Intelligent User Interfaces. 263-267. https://doi.org/abs/10.1145/3172944.3172988
[61] I Scott MacKenzie, Hedy Kober, Derek Smith, Terry Jones, and Eugene Skepner. 2001. LetterWise: Prefx-Based Disambiguation for Mobile Text Input. In Proceedings of the 14th Annual ACM Symposium on User Interface Software and Technology. 111-120. https://doi.org/10.1145/502348.502365
[62] 1 Scott MacKenzie and R William Soukoref. 2003. Phrase Sets for Evaluating Text Entry Techniques. In CHI'03 Extended Abstracts on Human Factors in Computing Systems. 754-755. https://doi.org/10.1145/765891.765971
[63] I Scott MacKenzie and Shawn X Zhang. 1999. The Design and Evaluation of a High-Performance Soft Keyboard. In Proceedings of the SIGCHI Conference on Human Factors in Computing Systems. 25-31. https://doi.org/10.1145/302979.302983
[64] I Scott MacKenzie and Xuang Zhang. 2008. Eye Typing Using Word and Letter Prediction and a Fixation Algorithm. In Proceedings of the 2008 Symposium on Eye Tracking Research & Applications. 55-58. https://doi.org/10.1145/1344471.1344484
[65] Päivi Majaranta, Ulla-Kaija Ahola, and Oleg S̆pakov. 2009. Fast Gaze Typing With an Adjustable Dwell Time. In Proceedings of the SIGCHI Conference on Human Factors in Computing Systems. 357-360. https://doi.org/10.1145/1518701.1518758
[66] Päivi Majaranta and Kari-Jouko Räihä. 2007. Text Entry by Gaze: Utilizing Eye-Tracking. Text Entry Systems: Mobility, Accessibility, Universality (2007), 175-187. https://doi.org/abs/10.1145/3313831.3376317
[67] Anders Markussen, Mikkel Rønne Jakobsen, and Kasper Hornbok. 2014. Vulture: a Mid-Air Word-Gesture Keyboard. In Proceedings of the SIGCHI Conference on Human Factors in Computing Systems. 1073-1082. https://doi.org/10.1145/2556288.2556964
[68] Brian McElree and Marisa Carrasco. 1999. The Temporal Dynamics of Visual Search: Evidence for Parallel Processing in Feature and Conjunction Searches. Journal of Experimental Psychology: Human Perception and Performance 25, 6 (1999), 1517. https://doi.org/10.1037/0096-1523.25.6.1517
[69] Mark McGill, Daniel Boland, Roderick Murray-Smith, and Stephen Brewster. 2015. A Dose of Reality: Overcoming Usability Challenges in VR Head-Mounted Displays. In Proceedings of the 33rd Annual ACM Conference on Human Factors in Computing Systems. 2143-2152. https://doi.org/10.1145/2702123.2702382
[70] Martez E Mott, Shane Williams, Jacob O Wobbrock, and Meredith Ringel Morris. 2017. Improving Dwell-Based Gaze Typing With Dynamic, Cascading Dwell Times. In Proceedings of the 2017 CHI Conference on Human Factors in Computing Systems. 2558-2570. https://doi.org/10.1145/3025453.3025517
[71] Peter Norvig. 2013. English Letter Frequency Counts: Mayzner Revisited or ETAOIN SRHLDCU. (2013).
[72] Midori Ohkita, Yoshie Obayashi, and Masako Jitsumori. 2014. Effcient Visual Search for Multiple Targets Among Categorical Distractors: Effects of DistractorDistractor Similarity Across Trials. Vision Research 96 (2014), 96-105. https://doi.org/10.1016/j.visres.2014.01.009
[73] Jakob Olofsson. 2017. Input and Display of Text for Virtual Reality HeadMounted Displays and Hand-Held Positionally Tracked Controllers.
[74] Alexander Otte, Tim Menzner, Travis Gesslein, Philipp Gagel, Daniel Schneider, and Jens Grubert. 2019. Towards Utilizing Touch-Sensitive Physical Keyboards for Text Entry in Virtual Reality. In 2019 IEEE Conference on Virtual Reality and 3D User Interfaces (VR). IEEE, IEEE, 1729-1732. https://doi.org/10.1109/VR.2019.8797740
[75] Antti Oulasvirta, Anna Reichel, Wenbin Li, Yan Zhang, Myroslav Bachynskyi, Keith Vertanen, and Per Ola Kristensson. 2013. Improving Two-Thumb Text Entry on Touchscreen Devices. In Proceedings of the SIGCHI Conference on Human Factors in Computing Systems. 2765-2774. https//doi.org/10.1145/2470654.2481383
[76] Farshid Salemi Parizi, Eric Whitmire, and Shwetak Patel. 2019. AuraRing: Precise Electromagnetic Finger Tracking. Proceedings of the ACM on Interactive, Mobile, Wearable and Ubiquitous Technologies 3, 4 (2019), 1-28. https://doi.org/10.1145/3369831
[77] Diogo Pedrosa, Maria Da Graga Pimentel, Amy Wright, and Khai N Truong. 2015. Filteryedping: Design Challenges and User Performance of Dwell-Free Eye Typing. ACM Transactions on Accessible Computing (TACCESS) 6, 1 (2015), 1-37. https://doi.org/10.1145/2724728
[78] Abdul Moiz Penkar, Christof Lutteroth, and Gerald Weber. 2012. Designing for the Eye: Design Parameters for Dwell in Gaze Interaction. In Proceedings of the 24th Australian Computer-Human Interaction Conference. 479-488. https://doi.org/10.1145/2414536.2414609
[79] Ken Perlin. 1998. Quikwriting: Continuous Stylus-Based Text Entry. In Proceedings of the 11th Annual ACM Symposium on User Interface Software and Technology. 215-216. https://doi.org/10.1145/288392.288613
[80] Duc-Minh Pham and Wolfgang Stuerzlinger. 2019. HawKEY: Effcient and Versatile Text Entry for Virtual Reality. In 25th ACM Symposium on Virtual Reality Software and Technology. 1-11. https://doi.org/10.1145/3359996.3364265
[81] Ryan Qin, Suwen Zhu, Yu-Hao Lin, Yu-Jung Ko, and Xiaojun Bi. 2018. OptimalT9: an Optimized T9-Like Keyboard for Small Touchscreen Devices. In Proceedings of the 2018 ACM International Conference on Interactive Surfaces and Spaces. 137-146. https://doi.org/10.1145/3279778.3279786
[82] Philip Quinn and Shumin Zhai. 2016. A cost-beneft study of text entry suggestion interaction. In Proceedings of the 2016 CHI conference on human factors in computing systems. 83-88.
[83] Vijay Rajanna and John Paulin Hansen. 2018. Gaze Typing in Virtual Reality: Impact of Keyboard Design, Selection Method, and Motion. In Proceedings of the 2018 ACM Symposium on Eye Tracking Research & Applications. 1-10. https://doi.org/10.1145/3204493.3204541
[84] Mark Richardson, Matt Durasof, and Robert Wang. 2020. Decoding Surface Touch Typing From Hand-Tracking. In Proceedings of the 33rd Annual ACM Symposium on User Interface Software and Technology. 686-696. https://doi.org/10.1145/3379337.3415816
[85] Jochen Rick. 2010. Performance Optimizations of Virtual Keyboards for StrokeBased Text Entry on a Touch-Based Tabletop. In Proceedings of the 23nd Annual ACM Symposium on User Interface Software and Technology. 77-86. https://doi.org/10.145/1866029.1866043
[86] Sherry Ruan, Jacob O Wobbrock, Kenny Liou, Andrew Ng, and James A Landay. 2018. Comparing Speech and Keyboard Text Entry for Short Messages in Two Languages on Touchscreen Phones. Proceedings of the ACM on Interactive, Mobile, Wearable and Ubiquitous Technologies 1, 4 (2018), 1-23. https://doi.org/10.1145/3161187
[87] Sayan Sarcar, Prateek Panwar, and Tuhin Chakraborty. 2013. EyeK: an Effcient Dwell-Free Eye Gaze-Based Text Entry System. In Proceedings of the 11th Asia Pacifc Conference on Computer Human Interaction. 215-220. https://doi.org/pdf/10.1145/2525194.2525288
[88] Weinan Shi, Chun Yu, Xin Yi, Zhen Li, and Yuanchun Shi. 2018. TOAST: TenFinger Eyes-Free Typing on Touchable Surfaces. Proceedings of the ACM on Interactive, Mobile, Wearable and Ubiquitous Technologies 2, 1 (2018), 1-23. https://doi.org/10.1145/3191765
[89] Shyamli Sindhwani, Christof Lutteroth, and Gerald Weber. 2019. ReType: Quick Text Editing With Keyboard and Gaze. In Proceedings of the 2019 CHI Conference on Human Factors in Computing Systems. 1-13. https://doi.org/10.1145/3290605.3300433
[90] Brian A Smith, Xiaojun Bi, and Shumin Zhai. 2015. Optimizing Touchscreen Keyboards for Gesture Typing. In Proceedings of the 33rd Annual ACM Conference on Human Factors in Computing Systems. 3365-3374. https://doi.org/10.1145/2702123.2702357
[91] R William Soukoref and I Scott MacKenzie. 2003. Metrics for Text Entry Research: an Evaluation of MSD and KSPC, and a New Unified Error Metric. In Proceedings of the SIGCHI Conference on Human Factors in Computing Systems. 113-120. https://doi.org/10.1145/642611.642632
[92] Marco Speicher, Anna Maria Feit, Pascal Ziegler, and Antonio Kriger. 2018. Selection-Based Text Entry in Virtual Reality. In Proceedings of the 2018 CHI Conference on Human Factors in Computing Systems. 1-13. https://doi.org/10. 1145/3173574.3174221
[93] Srinath Sridhar, Anna Maria Feit, Christian Theobalt, and Antti Oulasvirta. 2015. Investigating the Dexterity of Multi-Finger Input for Mid-Air Text Entry. In Proceedings of the 33rd Annual ACM Conference on Human Factors in Computing Systems. 3643-3652. https://doi.org/10.1145/2702123.2702136
[94] Bruce H Thomas and Wayne Piekarski. 2002. Glove Based User Interaction Techniques for Augmented Reality in an Outdoor Environment. Virtual Reality 6, 3 (2002), 167-180. https://doi.org/10.1145/988834.988871
[95] Keith Vertanen, Crystal Fletcher, Dylan Gaines, Jacob Gould, and Per Ola Kristensson. 2018. The Impact of Word, Multiple Word, and Sentence Input on Virtual Keyboard Decoding Performance. In Proceedings of the 2018 CHI Conference on Human Factors in Computing Systems. 1-12. https://doi.org/10.1145/3173574.3174200
[96] Keith Vertanen, Haythem Memmi, Justin Emge, Shyam Reyal, and Per Ola Kristensson. 2015. VelociTap: Investigating Fast Mobile Text Entry Using SentenceBased Decoding of Touchscreen Keyboard Input. In Proceedings of the 33rd Annual ACM Conference on Human Factors in Computing Systems. 659-668. https://doi.org/10,1145/2702123.2702135
[97] James Walker, Bochao Li, Keith Vertanen, and Scott Kuhl. 2017. Effcient Typing on a Visually Occluded Physical Keyboard. In Proceedings of the 2017 CHI Conference on Human Factors in Computing Systems. 5457-5461. Https://doi.org/10.1145/3025453.3025783
[98] Junjue Wang, Kaichen Zhao, Xinyu Zhang, and Chunyi Peng. 2014. Ubiquitous Keyboard for Small Mobile Devices: Harnessing Multipath Fading for FineGrained Keystroke Localization. In Proceedings of the 12th Annual International Conference on Mobile Systems. Applications, and Services. 14-27. https://doi.org/10.1145/2594368.2594384
[99] David J Ward, Alan F Blackwell, and David JC MacKay. 2000. Dasher-a Data Entry Interface Using Continuous Gestures and Language Models. In Proceedings of the 13th Annual ACM Symposium on User Interface Software and Technology. 129-137. https://doi.org/10.1145/354401.354427
[100] Pierre Weill-Tessier, Jayson Turner, and Hans Gellersen. 2016. How do you look at what you touch? A study of touch interaction and gaze correlation on tablets. In Proceedings of the Ninth Biennial ACM Symposium on Eye Tracking Research & Applications. 329-330.
[101] Eric Whitmire, Mohit Jain, Divye Jain, Greg Nelson, Ravi Karkar, Shwetak Patel, and Mayank Goel. 2017. Digitouch: Reconfgurable Thumb-to-Finger Input and Text Entry on Head-Mounted Displays. Proceedings of the ACM on Interactive, Mobile, Wearable and Ubiquitous Technologies 1, 3 (2017), 1-21. https://doi.org/10.1145/3130978
[102] Pui Chung Wong, Kening Zhu, and Hongbo Fu. 2018. Fingert9: Leveraging Thumb-to-Finger Interaction for Same-Side-Hand Text Entry on Smartwatches. In Proceedings of the 2018 CHI Conference on Human Factors in Computing Systems. 1-10. https://doi.org/10.1145/3173574.3173752
[103] Wenge Xu, Hai-Ning Liang, Anqi He, and Zifan Wang. 2019. Pointing and Selection Methods for Text Entry in Augmented Reality Head Mounted Displays. In 2019 IEEE International Symposium on Mixed and Augmented Reality (ISMAR). IEEE, IEEE, 279-288. https://doi.org/10.1109/ISMAR.2019.00026
[104] Wenge Xu, Hai-Ning Liang, Yuxuan Zhao, Tianyu Zhang, Difeng Yu, and Diego Monteiro. 2019. RingText: Dwell-Free and Hands-Free Text Entry for Mobile Head-Mounted Displays Using Head Motions. IEEE Transactions on Visualization and Computer Graphics 25, 5 (2019), 1991-2001. https://doi.org/10.1109/TVCG. 2019.2898736
[105] Zheer Xu, Weihao Chen, Dongyang Zhao, Jiehui Luo, Te-Yen Wu, Jun Gong, Sicheng Yin. Jialun Zhai, and Xing-Dong Yang. 2020. BiTipText: Bimanual Eyes-Free Text Entry on a Fingertip Keyboard. In Proceedings of the 2020 CHI Conference on Human Factors in Computing Systems. 1-13. https://doi.org/fullHtml/10.1145/3313831.3376306
[106] Naoki Yanagihara, Buntarou Shizuki, and Shin Takahashi. 2019. Text Entry Method for Immersive Virtual Environments Using Curved Keyboard. In 25th ACM Symposium on Virtual Reality Software and Technology. 1-2. https://doi. org/abs/10.1145/3173574.3174221
[107] Xin Yi, Chen Wang, Xiaojun Bi, and Yuanchun Shi. 2020. PalmBoard: Leveraging Implicit Touch Pressure in Statistical Decoding for Indirect Text Entry. In Proceedings of the 2020 CHI Conference on Human Factors in Computing Systems. 1-13. https://doi.org/abs/10.1145/3313831.3376441
[108] Xin Yi, Chun Yu, Mingrui Zhang, Sida Gao, Ke Sun, and Yuanchun Shi. 2015. Atk: Enabling Ten-Finger Freehand Typing in Air Based on 3d Hand Tracking Data. In Proceedings of the 28th Annual ACM Symposium on User Interface Software & Technology. 539-548. https://doi.org/pdf/10.1145/2807442.2807504
[109] Yafeng Yin, Qun Li, Lei Xie, Shanhe Yi, Edmund Novak, and Sanglu Lu, 2016. CamK: a Camera-Based Keyboard for Small Mobile Devices. In IEEE INFOCOM 2016—The 35th Annual IEEE International Conference on Computer Communications. IEEE, IEEE, 1-9. https://doi.org/abs/10.1109/INFOCOM.2016.7524400
[110] Chun Yu, Yizheng Gu, Zhican Yang, Xin Yi, Hengliang Luo, and Yuanchun Shi. 2017. Tap, Dwell or Gesture?Exploring Head-Based Text Entry Techniques for HMDs. In Proceedings of the 2017 CHI Conference on Human Factors in Computing Systems. 4479-4488. https://doi.org/10.1145/3025453.3025964
[111] Chun Yu, Ke Sun, Mingyuan Zhong, Xincheng Li, Peijun Zhao, and Yuanchun Shi. 2016. One-Dimensional Handwriting: Inputting Letters and Words on Smart Glasses. In Proceedings of the 2016 CHI Conference on Human Factors in Computing Systems. 71-82. https://doi.org/10.1145/2858036.2858542
[112] Difeng Yu, Kaixuan Fan, Heng Zhang, Diego Monteiro, Wenge Xu, and HaiNing Liang. 2018. PizzaText: Text Entry for Virtual Reality Systems Using Dual Thumbsticks. IEEE Transactions on Visualization and Computer Graphics 24, 11 (2018), 2927-2935. https://doi.org/10.1109/TVCG.2018.2868581
[113] Shumin Zhai, Michael Hunter, and Barton A Smith. 2002. Performance Optimization of Virtual Keyboards. Human-Computer Interaction 17, 2-3 (2002), 229-269. https://doi.org/10.1145/1866029.1866043
[114] Mingrui Ray Zhang, He Wen, and Jacob O Wobbrock. 2019. Type, Then Correct: Intelligent Text Correction Techniques for Mobile Text Entry Using Neural Networks. In Proceedings of the 32nd Annual ACM Symposium on User Interface
[115] Suwen Zhu, Tianyao Luo, Xiaojun Bi, and Shumin Zhai. 2018. Typing on an Software and Technology. 843-855. https://doi.org/10.1145/3332165.3347924 Invisible Keyboard. In Proceedings of the 2018 CHI Conference on Human Factors in Computing Systems. 1-13. https://doi.org/10.1145/3173574.3174013

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. An apparatus for entering text by movement of fingers of a user having an eye comprising:
a sensor in communication with at least one finger of the fingers which detects movement of the at least one finger and produces a finger signal;
a computer in communication with the sensor which receives the finger signal and associates proposed text with the finger signal;
a display in communication with the computer upon which the proposed text is displayed; and
an eye tracker in communication with the computer, the computer selecting desired text from the proposed text on the display based on the eye tracker identifying where the eye of the user gazes.

2. The apparatus of claim 1 including a virtual reality headset having the display which displays a virtual reality and the proposed text in the virtual reality.

3. The apparatus of claim 2 wherein the computer receives a second finger signal from the sensor which causes the computer to select the desired text.

4. The apparatus of claim 3 wherein the computer selecting the desired text based on either direct gaze pointing with dwell, eye switches, discrete gaze gestures, or continuous gaze.

5. The apparatus of claim 4 wherein the computer tracks and visualizes a physical keyboard in the virtual reality to facilitate keyboard text entry in virtual reality.

6. The apparatus of claim 5 wherein the computer displays the proposed text either a Lexical Layout, a WordCloud Layout, a Division Layout, or a Pentagon Layout.

7. The apparatus of claim 6 wherein the fingers include eight non-thumb fingers and two thumbs and the computer uses finger to letter mapping where each of the 26 letters of the alphabet is mapped to at least one of the eight non-thumb fingers, while the two thumbs are reserved for controlling editing functions for word selection, undoing a selection, deletion and cursor navigation.

8. The apparatus of claim 7 wherein the computer enables text entry by finger tapping by assigning multiple letters to each finger and showing text suggestions in the display and allowing the user to select desired text via the user's gaze and determine the desired text selection via a thumb tap.

9. The apparatus of claim 8 wherein the computer displays a color-coded keyboard layout in the display.

10. The apparatus of claim 9 wherein the finger-to-letter mapping is based on a QWERTY keyboard layout.

11. A method for entering text by movement of fingers of a user having an eye comprising the steps of:
moving at least one finger of the fingers;
causing a sensor in communication with the at least one finger to produce a finger signal;
receiving the finger signal at a computer;
associating by the computer proposed text with the finger signal;
displaying on the display the proposed text;
identifying with an eye tracker where the user gazes onto the proposed text displayed on a display; and
selecting desired text from the proposed text by the computer based on the eye tracker identifying where the eye of the user gazes.

12. The method of claim 11 including a virtual reality headset having the display and including the step of displaying a virtual reality on the display and the proposed text in the virtual reality.

13. The method of claim 12 including the step of the computer receiving a second finger signal from the sensor which causes the computer to select the desired text.

14. The method of claim 13 including the steps of the computer tracking and visualizing a physical keyboard in the virtual reality to facilitate keyboard text entry in virtual reality.

15. The method of claim 14 wherein the fingers include eight non-thumb fingers and two thumbs and the computer using finger to letter mapping where each of the 26 letters of the alphabet is mapped to at least one of the eight non-thumb fingers, while the two thumbs are reserved for controlling editing functions for word selection, undoing a selection, deletion and cursor navigation.

16. The method of claim 15 including the step of the computer enabling text entry by finger tapping by assigning multiple letters to each finger and showing text suggestions in the display and allowing the user to select desired text via the user's gaze and determine the desired text selection via a thumb tap.

17. The method of claim 16 including the step of the computer displaying a color-coded keyboard layout in the display.

18. A non-transitory readable storage medium which includes a computer program stored on the storage medium for entering text by movement of fingers of a user having an eye having the computer-generated steps of:
associating proposed text from a finger signal obtained from a sensor in communication with at least one finger of the fingers moving;
displaying on a display of a virtual reality headset the proposed text;
identifying from an eye tracker where the user gazes onto the proposed text displayed on a display; and
selecting desired text from the proposed text based on the eye tracker identifying where the eye of the user gazes.

19. The storage medium of claim 18 also having the computer-generated step of selecting the desired text from a second finger signal from the sensor.

20. An apparatus for entering text by movement of fingers of a user having an eye comprising:
a sensor in communication with at least one finger of the fingers which detects movement of the at least one finger and produces a finger signal;
a computer in communication with the sensor which receives the finger signal and associates proposed text with the finger signal; and
a display of a virtual reality headset in communication with the computer upon which the proposed text is displayed, the computer selecting desired text from the proposed text on the display based on at least one additional finger signal from the sensor.
